(19) United States
(12) Patent Application Publication
(10) Pub. No.: US 2017/0227995 A1
(43) Pub. Date: Aug. 10, 2017

(54) METHOD AND SYSTEM FOR IMPLICIT AUTHENTICATION

(71) Applicants: Ruby B. Lee, Princeton, NJ (US); Wei-Han Lee, Princeton, NJ (US)

(72) Inventors: Ruby B. Lee, Princeton, NJ (US); Wei-Han Lee, Princeton, NJ (US)

(73) Assignee: The Trustees of Princeton University, Princeton, NJ (US)

(21) Appl. No.: 15/428,306

(22) Filed: Feb. 9, 2017

Related U.S. Application Data
(60) Provisional application No. 62/293,152, filed on Feb. 9, 2016.

(51) Int. Cl. G06F 1/16; G06F 3/0488; H04L 29/06; G06F 21/32; H04W 12/12; H04W 12/06; G06F 3/01; G06F 21/31

(52) U.S. Cl. CPC G06F 1/1694; G06F 3/017; G06F 3/04883; G06F 21/316; G06F 21/32; H04W 12/12; H04W 12/06; H04L 63/10; H04L 63/0892; G06F 2221/21

(57) ABSTRACT

A method and system capable of implicitly authenticating users based on information gathered from one or more sensors, which may be located in one or more devices, and an authentication model trained via a machine learning technique. Data is collected, manipulated, and assessed with the authentication model in order to determine if the user is authentic. A wide variety of sensors may be utilized, including sensors in smartphones, smartwatches, other wearable devices, and other sensors accessible via an internet of things (IoT) system. The method and system can include continuously testing the user's behavior patterns and environment characteristics, and allowing authentication without interrupting the user's other interactions with a given device or requiring explicit user input. The method and system may also involve the authentication model being retrained, or adaptively updated to include temporal changes in the user's patterns.

### CROSS-REFERENCE TO RELATED APPLICATIONS

This application claims benefit of U.S. Provisional Application No. 62/293,152, filed Feb. 9, 2016, which is hereby incorporated in its entirety by reference.

### STATEMENT REGARDING FEDERALLY SPONSORED RESEARCH OR DEVELOPMENT

This invention was made with government support under Grant CNS-1218817 awarded by the National Science Foundation. The government has certain rights in the invention.

### BACKGROUND OF THE INVENTION

Recent years have witnessed an increasing development of mobile devices such as smartphones and tablets. Smartphones are also becoming an important means for accessing various online services, such as online social networks, email and cloud computing. Many applications and websites allow users to store their information, passwords, etc. Users also save various contact information, photos, schedules and other personal information in their smartphones.

No one wants personal and sensitive information to be leaked to others without their permission. However, the smartphone is easily stolen, and the attacker can have access to the personal information stored in the smartphone. Furthermore, the attacker can steal the victim's identity and launch impersonation attacks in networks, which would threaten the victim's personal and sensitive information like his bank account, as well as the security of the networks, especially online social networks. Therefore, providing reliable access control of the information stored on smartphones, or accessible through smartphones, is very important.

Public clouds offer elastic and inexpensive computing and storage resources to both companies and individuals. Cloud customers can lease computing resources, like Virtual Machines, from cloud providers to provide web-based services to their own customers—who are referred to as the end-users. Past efforts for protecting a cloud customer's Virtual Machines tended to focus on attacks within the cloud from malicious Virtual Machines that are co-tenants on the same servers, or from compromised Virtual Machine Monitors, or from network adversaries. However, end-users can also pose serious security threats. Consider the increasingly common situation of accessing cloud-based services and data through a smartphone. Users register accounts for these services. Then they login to their accounts from their smartphones and use these cloud services. However, after log-in, the user may leave her smartphone un-attended or it may be co-opted by an attacker, and now the attacker has legitimate access to the cloud-based services and data or the sensitive data stored in the smartphone itself. Ideally, smartphone users should re-authenticate themselves, but this is inconvenient for legitimate users and attackers have no incentive to “re-authenticate.”

Further, smartphones themselves store private, sensitive and secret information related to people's daily lives. Users do not want these accessible to an attacker who has stolen the device, or has temporary access to it. Current smartphones use passwords or biometrics to authenticate the end-users during their initial login to the devices or to protected cloud services. These may be insufficient for many use cases. First, users often choose poor passwords, and passwords are vulnerable to guessing and dictionary attacks, and password reuse. Also, biometrics are vulnerable to forgery attacks. A recent report shows that a lot of users disable these authentication methods simply because they are inconvenient. Second, using just initial login authentication is not enough, since adversaries can take control of the users' smartphones, after the legitimate users' initial login. Then the adversaries can access the services and data, which may be proprietary and sensitive, whether stored in the cloud or in the mobile device itself. To protect data and services, whether in the cloud or in the smartphone itself, from adversaries who masquerade as legitimate end-users, what is needed is a secure and usable re-authentication system, which is ideally both implicit and continuous. An implicit authentication method does not rely on the direct involvement of the user, but is closely related to her behavior, habits or living environment. This is more convenient than having to re-enter passwords or pins. A continuous re-authentication method should keep authenticating the user, in addition to the initial login authentication. This can detect an adversary once he gets control of the smartphone and can prevent him from accessing sensitive data or services via smartphones, or inside smartphones.

### BRIEF SUMMARY OF THE INVENTION

The present invention is directed to methods and systems capable of implicitly authenticating users based on information gathered from one or more sensors and an authentication model trained via a machine learning technique.

In the present invention, methods and systems are provided in which an authentication model is trained using one or more machine learning techniques, and then, data is collected, manipulated, and assessed with the authentication model in order to determine if the user is authentic.

Among the many different possibilities contemplated, the sensors may include motion and/or non-notion sensors, including but not limited to accelerometers, gyroscopes, magnetometers, heart rate monitors, pressure sensors, or light sensors, which may be located in different devices, including smartphones, wearable devices (including hut not limited to smartwatches and smartglasses), implantable devices, and other sensors accessible via an internet of things cloT) system. Further, the method can include continuously testing the user's behavior patterns and environment characteristics, and allowing authentication without interrupting the user's other interactions with a given device or requiring user input. The method may also involve the authentication model being retrained, or adaptively updated to include temporal changes in the user's patterns, where the retraining can include, but is not limited to, incorporating new data into the existing model or using an entirely new set of data. The retraining may occur automatically when the system determines that confidence in the authentication has been too low for a sufficiently long period of time, such as when the confidence score for multiple authentications within a 20 second period are below 0.2. The method may also include determining context of the measurements. The authentication may also involve the use of multiple features from the measurements, including one or more frequency domain features, one or more time domain features, or a combination of the two. The machine learning technique that is utilized can include, but is not limited to, decision trees, kernel ridge regression, support vector machine algorithms, random forest, naïve Bayesian, k-nearest neighbors (K-NN), and least absolute shrinkage and selection operator (LASSO). Unsupervised machine learning algorithms and Deep Learning algorithms can also be used. The method may also involve preventing unauthorized users from gaining access to a device or a system accessible from the device without requiring explicit user-device interaction. The method may also include an enrollment phase that includes receiving sensor data, sending the data for use in training an authentication model, and receiving the authentication model, whether the training is done by a remote server, or by the device itself such as a smartphone. In response to a failed authorization attempt, the method may also include blocking further access to a device or generating an alert. The sensor sampling rate may also be adjustable. This method may be conducted via a smartphone application. As such, it may also include utilizing sensors that do not generate data that is of concern for privacy, that would have required permission for those measurements to be used if they were used on the smartphone (such as GPS sensors, camera sensors, or microphones). The method may also include rapidly training an authentication model, such as when the training time is less than about 20 seconds. The method may also be utilized when the sensor is in one device, the authentication is accomplished in a second device, and a third device is optionally requesting the results of the authentication.

### BRIEF DESCRIPTION OF DRAWINGS

FIG. 1 is a flowchart of one embodiment of a method for implicit authorization.

FIG. 2 is a flowchart of one embodiment of an enrollment method.

FIGS. 3A-3D depict one example of three extracted features in the frequency domain, for two different users.

FIGS. 4A-4F depicts sensor streams corresponding to different sensor dimensions for two different users.

FIGS. 5A-5B depict KS test results for a subset of sensor features.

FIG. 6 provides average correlation coefficients for various features.

FIG. 7 illustrates false acceptance rates and false rejection rates for one embodiment.

FIGS. 8A-8D illustrates false acceptance rates and false rejection rates for three embodiments under two different contexts.

FIG. 9 illustrates overall authentication accuracy for one embodiment at varying data sizes.

FIG. 10 is a flowchart of one embodiment of a test method.

FIG. 11A is an illustration of the concept of behavioral drift.

FIG. 11B depicts confidence scores of authentication feature vectors for a user over a period of 12 days.

FIG. 12 depicts the fraction of adversaries that are recognized as legitimate users by a test system over time.

FIG. 13 is an illustration of the concept of SVM classification.

FIGS. 14A and 14B are graphical representations of accuracy data from single-sensor-based systems using two different data sets.

FIGS. 15A and 15B are graphical representations of accuracy data from dual-sensor-based systems using two different data sets.

FIGS. 16A and 16B are graphical representations of accuracy data from one-sensor, two-sensor and three-sensor systems using two different data sets.

FIGS. 17A and 17B depict training times for various sampling intervals of a given embodiment for two different data sets.

FIGS. 18A and 18B depict training times and accuracy for various data sizes of a given embodiment for two different data sets.

FIGS. 19A and 19B depict authentication accuracy for various sampling intervals utilizing two different machine learning techniques for two different data sets.

FIGS. 20-23 depict embodiments of various systems for implicit authentication.

### DETAILED DESCRIPTION OF THE INVENTION

Reference is now made in detail to the description of the invention as illustrated in the drawings. While the invention will be described in connection with these drawings, there is no intent to limit it to the embodiment or embodiments disclosed therein.

The present invention is directed to methods and systems capable of implicitly authenticating users based on information gathered from one or more sensors and an authentication model trained via a machine learning technique.

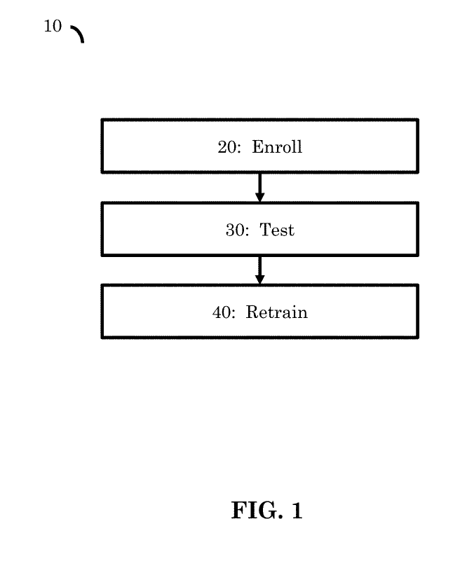

FIG. 1 illustrates the general phases that may be involved in the authentication method.

The method (10) begins with an enrollment phase (20). Initially, the system must be trained in an enrollment phase. In preferred embodiments, this is done whenever a new user needs to be authenticated, or whenever sensors are added or removed from the authentication system. The output from the enrollment phase is at least one authentication model or classifier for the use by a device for authenticating a user. For embodiment, when users want to use a smartphone to access sensitive data or cloud services, the system starts to monitor the sensors and extract particular features from the sensors' data. This process continues and the data should be stored in a protected buffer in the smartphone until the distribution of the collected features converges to an equilibrium, which means the size of data can provide enough information to build a user's profile with sufficient accuracy.

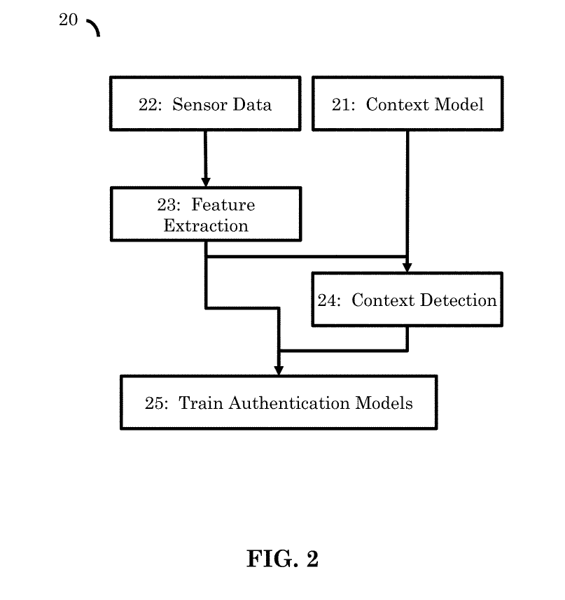

One embodiment of the enrollment phase is depicted in FIG. 2. At the simplest level, sensor data is first gathered (22). This data can be gathered in a variety of ways; for example, a sensor can be continuously sending data or the sensor can send data only in certain conditions. For example, a given sensor may only send data continuously when it detects motion, or a given sensor may be requested to send data gathered within a period of time before, during, and after when a legitimate user is using an explicit form of authentication (such as signing in with a password, pin, or using some biometric sensor). Once the data is sent, features of that sensor data are extracted (23), and an authentication model is trained (25) based on those extracted features. In some embodiments, a context model (21) is used to improve accuracy. The use of context models stems from the observation that users' behavioral patterns are often different from person to person, and vary under different usage contexts, when they use devices such as smartphones and wearables such as smartwatches or smartglasses. For embodiment, a person's behavior may be different when they are walking versus when they are riding a subway, versus when they are sitting in a chair at home. Instead of authenticating the user with one unified model, it may be better to utilize different finer-grained models to authenticate the user based on different usage contexts. For embodiment, using a user's walking behavioral model to authenticate the same user who is sitting while using the smartphone will likely be less accurate than having an authentication process that determines whether the user is walking or sitting, then using the appropriate authentication model. Thus, in FIG. 2, some or all of the extracted features (23), which may all be in the frequency domain, all in the time domain, or some combination of both, can be combined with the context model (21) to enable a system to detect context (24). That detected context (24) can be used with some or all of the extracted features (23) to train the authentication model (25) as well.

The context information, when carefully chosen, can be user-agnostic: the context of the current user can be detected (24) prior to authenticating the user. In one embodiment, the usage context was first differentiated, and then a fine-grained authentication model was utilized to implement authentication under each different context. In this embodiment, when the context detection model evaluates a user, it uses a model (i.e., classifier) that was trained with other user's data, such that the context detection model could be user-agnostic. Thus, a service provider can pre-train a user-agnostic context detection model for the users to download when they first enroll, or have it pre-installed on a device. Updates to the context detection model can also be downloaded or sent to the device.

In one embodiment, the signals of the sensors' data are segmented into a series of time windows. For context detection, the data collected by the accelerometer and the ambient light sensor were utilized because they represent certain distinctive patterns of different contexts. In another embodiment, data from a gyroscope and accelerometer were utilized for differentiating moving or stationary contexts. In these embodiments, the magnitude of each sensor data was computed. In some embodiments, the magnitude of an accelerometer data sample (t, x, y, z), is computed as m=\sqrt{x²+y²+z²}. In other embodiments, the magnitude of data sample (t, x, y, z) may be computed as m=x+y+z. Discrete Fourier transform (DFT) can be implemented to obtain the frequency domain information. The frequency domain information is useful and is widely used in signal processing and data analysis, e.g., speech signals and images.

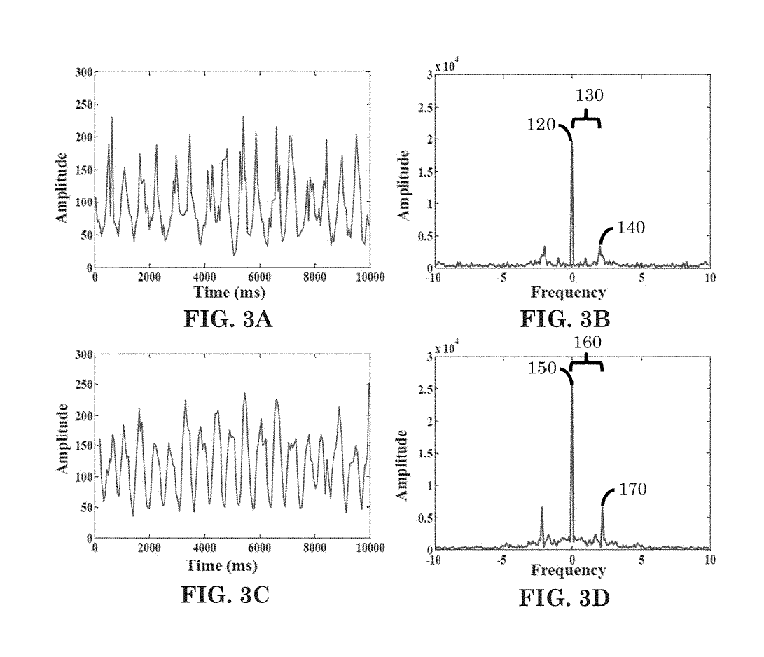

FIGS. 3A-3D shows an example of three extracted features in the frequency domain, for two different users (user 1=FIGS. 3A, 3B; user 2=FIGS. 3C, 3D). The extracted features in this embodiment include: the amplitude of the first highest peak (120, 150), which represents the energy of the entire sensors' information within the window; the frequency of the second highest peak (130, 160), which represents the main walk frequency; and the amplitude of the second highest peak (140, 170), which corresponds to the energy of the sensors' information under this dominant periodicity.

In such an arrangement, the feature vector for a sensor in a given time window k-for a device, such as a smartphone, can be shown as incorporating both time domain and frequency domain features:

SPᵢ(k)=[SPᵢ^{t}(k),SPᵢ^{f}(k)] (Eq. 1)

One embodiment can have a selection of four time domain features and three frequency domain features where:

SPᵢ^{t}(k)=[mean(Sᵢ(k)),var(Sᵢ(k)),max(Sᵢ(k)),min(Sᵢ(k))]

SPᵢ^{f}(k)=[peak(Sᵢ(k)),freq(Sᵢ(k)),peak2(Sᵢ(k))] (Eq. 2)

Other embodiments can have a different selection of features.

Then, the authentication feature vector for the smartphone is:

SPᵢ^{f}(k)=[SPₛₑₙₛₒᵣ_{_}₁(k),SPₛₑₙₛₒᵣ_{_}₂(k), . . . SPₛₑₙₛₒᵣ_{_}ₙ(k)] (Eq. 3)

if n sensors are used for detection, where n can be an integer equal to or greater than 1.

Similarly, this method can also utilize the feature vector for the sensor data from (in this embodiment) the smartwatch, denoted SW (k). Therefore, the authentication feature vector for training the authentication model for this embodiment is:

Authenticate(k)=[SP(k),SW(k)] (Eq. 4)

A similar approach can be used for determining the context; however, this can be simpler. In one embodiment, it may only use features from the smartphone and not the smartwatch:

Context(k)=[SP(k),SW(k)] (Eq. 5)

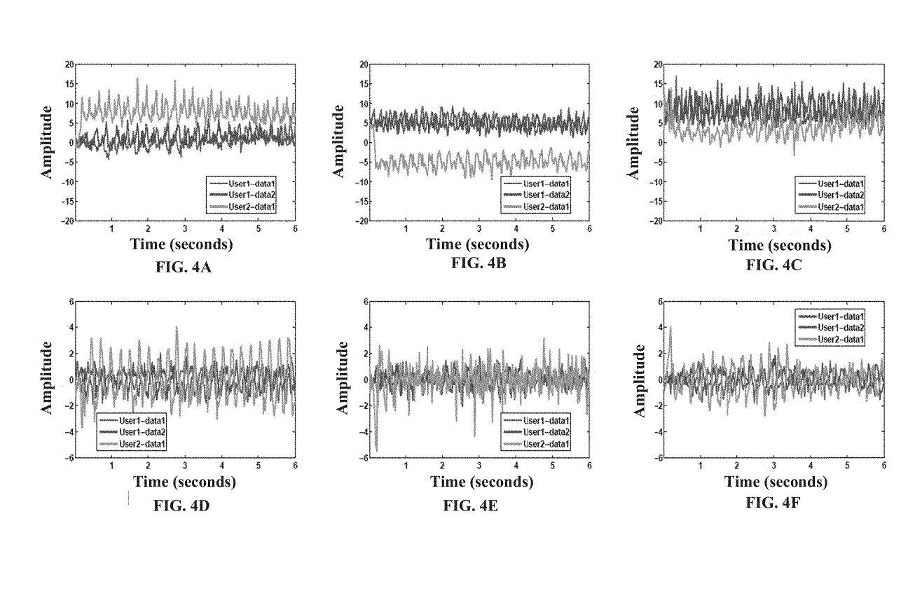

While the same feature vectors can be used for determining the context as for training the authentication model, preferred embodiments are configured whereby some or all of the features or feature vectors used for training the authentication model are different from the features or feature vectors used for determining context, and in more preferred embodiments, the authentication model utilizes more feature vectors than are used in determining context. The ability to differentiate users can be seen in FIGS. 4A-4F. Sensor data streams from different users were collected. FIGS. 4A-4F depict the sensor streams corresponding to different sensor dimensions (accelerometer x, y, z, and gyroscope x, y, z). For each sensor dimension, two signals from the same user (red and blue (dark) lines) are randomly selected, and a signal from another user (green (light) lines) is shown. It can be see that the two sensor signals from the same user are more similar than that from different users.

Rather than utilize every sensor feature, it may be beneficial to utilize only those features likely to be beneficial to distinguishing users. In one embodiment, the following statistical features derived from each of the raw sensor streams were computed in each time window: Mean: Average value of the sensor stream; Var: Variance of the sensor stream; Max: Maximum value of the sensor stream; Min: Minimum value of the sensor stream; Ran: Range of the sensor stream; Peak: The amplitude of the main frequency of the sensor stream; Peak f: The main frequency of the sensor stream; Peak2: The amplitude of the secondary frequency of the sensor stream; and Peak2 f: The secondary frequency of the sensor stream. In this embodiment, the performance of each feature can be tested, and the “bad” features can be dropped. If a feature can be used to easily distinguish two users, the feature is considered a “good” feature. For a feature to distinguish two different persons, it is necessary for the two underlying distributions to be different. Each feature was tested as to whether the feature derived from different users was from the same distribution. If most pairs of them are from the same distribution, the feature is “bad” in distinguishing two persons and it can be dropped.

In one embodiment, the Kolmogorov-Smirnov test (KS test) was used to test if two data sets are significantly different. The KS test is a nonparametric statistical hypothesis test based on the maximum distance between the empirical cumulative distribution functions of the two data sets. The two hypotheses of a KS test are:

H₀: the two data sets are from the same distribution.

H₁: the two data sets are from different distributions.

A KS test reports a p-value, i.e. the probability that obtaining the maximum distance is at least as large as the observed one when H₀ is assumed to be true. i.e., H₀ is accepted. If this p-value is smaller than α, usually set to 0.05, the H₀ hypothesis can be rejected because events with small probabilities rarely happen (rejecting H₀ and accepting H₁), indicating a “good” feature for distinguishing users. For each feature, the p-value for data points for each pair of users is calculated, and a feature could be dropped if most of its p-values are higher than α.

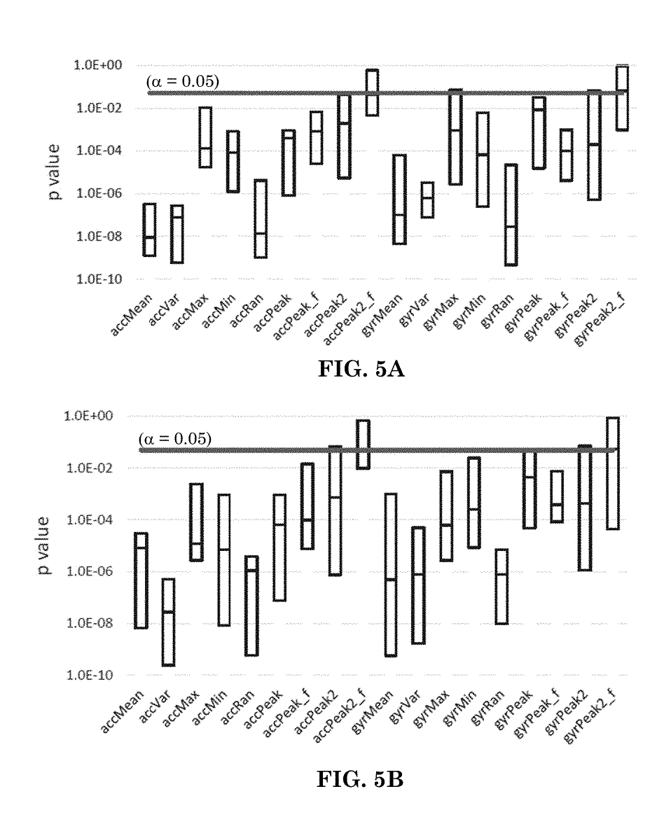

FIGS. 5A and 5B show the testing results for the features in both the smartphone (FIG. 5A) and smartwatch (FIG. 5B). For each feature, the resulting p-values are drawn in a box plot. The bottom and the top lines of the box denote the lower quartile Q1 and upper quartile Q2, defined as the 25th and the 75th percentiles of the p-values. The middle bar denotes the median of the p-values. The y-axes in FIGS. 5A and 5B are in logarithmic scale. The red lines in the figures represent the significance level α=0.05. The better a feature is, the more of its box plot is below the red line. It denotes that more pairs are significantly different. From FIGS. 5A and 5B, it can be seen that the accPeak2_f and gyrPeak2_f in both the smartphone and the smartwatch are “bad” features, so in one embodiment, they could be dropped with minimal impact on accuracy.

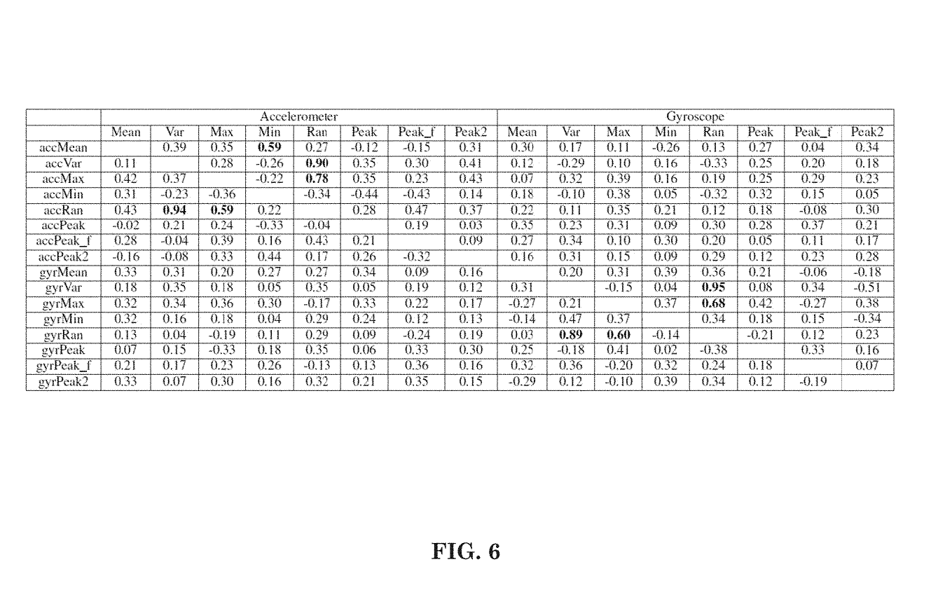

Next, redundant features can also be considered, by computing the correlation between each pair of features. A strong correlation between a pair of features indicates that they are similar in describing a user's behavior pattern, so one of the features can be dropped. A weak correlation implies that the selected features reflect different behaviors of the user, so both features should be kept. The Pearson's correlation coefficient can be calculated between any pair of features. Then, for every pair of features, the average of all resulting correlation coefficients over all the users was taken. FIG. 6 shows the resulting average correlation coefficients. The upper right triangle is the correlation between features in the smartphone, while the lower left triangle is the correlation between features in the smartwatch. It can be seen that Ran has very high correlation with Var in each sensor on both the smartphone and smartwatch, which means that Ran and Var have information redundancy. Also Ran has relatively high correlation with Max. Therefore, Ran can be dropped from the feature set with minimal impact on accuracy.

Once extracted, some or all of these features may be placed into the context detection component to decide the specific context the current user is in. In some embodiments, features from only one device are utilized, even if multiple devices are used for authentication.

In one embodiment, a Decision Tree Classifier was utilized. Decision Tree Classifier is a method commonly used in data mining. In another embodiment, a Random forest algorithm was chosen, although many other machine learning algorithms could be utilized here. The goal is to create a model that predicts the value of a target variable based on several input variables. Here, the training data is first used to train a context detection tree, and then the testing data is fed to the constructed decision tree and the resulting leaf outputs the context label of the testing data.

Although there are a variety of methods for developing context models, in this embodiment, the data for building a context model was gathered by asking subjects to use a smartphone and the smartwatch freely under each of the contexts for 20 minutes, and to stay in the current context until the experiment is finished.

The context decision tree in the embodiment data set was evaluated with 10-fold cross-validation and the confusion matrix is shown in Table I. The context detection method achieved high accuracy under four different contexts: movement inside a building, moving up or down stairs, moving outside, and standing still (static). The worst accuracy for the inside context can achieve more than 97% and the average accuracy for the four contexts is 98.1%. This provides fine-grained context information for the next-step authentication process. It is observed that the time for a context to be detected is within 4.5 milliseconds on the smartphone, which is fast and thus applicable in real world scenarios.

For the interpretation of the context decision tree trained over in this embodiment, it should be noted that: 1) the accelerometer could be used to differentiate the stationary context from the other three moving contexts; 2) the ambient light could further differentiate the outside movement from the inside movement and up/downstairs movement contexts; 3) the accelerometer could be used to further differentiate the inside and up/downstairs contexts. Based on these observations of the decision tree, it is recognized that it is naturally separable for these different contexts without dependence on the users. Therefore, the preferred user-agnostic context decision tree can provide accurate context detection performance for different usage contexts within an acceptable processing time.

Considering the scenario where the smartphone and smartwatch may not always be connected with each other, this system can also implement a context detection method by only using the smartphone, smartwatch, or some other set of sensors entirely. The confusion matrices are shown in Table II and Table III, respectively. Comparing with Table I, it is seen that combining the smartphone and smartwatch together can provide better context detection performance than using any individual device, which shows the benefits of using multiple devices in a system.

TABLE I
(Combination Smartphone and Smartwatch).

| | | Detected Context | | | |
|---|---|---|---|---|---|
| | | Inside | Up/Down | Outside | Static |
| Actual | Inside | 97.1% | 1.7% | 0.8% | 0.4% |
| Context | Up/Down | 0.7% | 98.6% | 0.5% | 0.2% |
| | Outside | 0.9% | 1.3% | 97.6% | 0.2% |
| | Static | 0.4% | 0.5% | 0.3% | 98.8% |

TABLE II
(Smartphone only).

| | | Detected Context | | | |
|---|---|---|---|---|---|
| | | Inside | Up/Down | Outside | Static |
| Actual | Inside | 92.8% | 3.1% | 2.2% | 1.9% |
| Context | Up/Down | 2.1% | 94.2% | 2.0% | 1.7% |
| | Outside | 2.3% | 2.8% | 93.4% | 1.5% |
| | Static | 1.8% | 2.0% | 1.6% | 94.6% |

TABLE III
(Smartwatch only).

| | | Detected Context | | | |
|---|---|---|---|---|---|
| | | Inside | Up/Down | Outside | Static |
| Actual | Inside | 90.9% | 3.7% | 2.9% | 2.5% |
| Context | Up/Down | 3.1% | 92.1% | 2.8% | 2.0% |
| | Outside | 3.2% | 3.6% | 91.4% | 1.8% |
| | Static | 2.1% | 2.2% | 3.2% | 92.5% |

In another embodiment, four contexts were initially tested: (1) the user uses the smartphone without moving around, e.g., while standing or sitting; (2) the user uses the smartphone while moving. No constraints are set for how the user moves; (3) the smartphone is stationary (e.g., on a table) while the user uses it; (4) the user uses the smartphone on a moving vehicle, e.g., train. However, in this embodiment, it was found that these four contexts cannot be easily differentiated: contexts (3) and (4) are easily misclassified as context (1), since (1), (3) and (4) are all relatively stationary, compared to context (2). Therefore, contexts (1), (3) and (4) were combined into one stationary context, while (2) was left as the moving context. The resulting confusion matrix in Table IV showed a very high context detection accuracy of over 99% with these 2 simple contexts. The context detection time was also very short—less than 3 milliseconds.

TABLE IV
(Smartphone only).

Detected Context

| | | Stationary | Moving |
|---|---|---|---|
| Actual | Stationary | 99.1% | 0.9% |
| Context | Moving | 0.6% | 99.4% |

Before training the authentication model, it is useful to understand which sensors may be of value in distinguishing users. Mobile sensing technology has matured to a state where collecting many measurements through sensors in smartphones is now becoming quite easy through, for embodiment, Android sensor APIs. Mobile sensing applications, such as the CMU MobiSens, run as a service in the background and can constantly collect sensors' information from smartphones. Sensors can be either hard sensors (e.g., accelerometers) that are physically-sensing devices, or soft sensors that record information of a phone's running status (e.g., screen on/off). Thus, practical sensors-based user authentication can be achieved today. While any and all sensors can be utilized, preferred embodiments utilize a finite subset of all available sensors.

In one embodiment, Fisher scores (FS) were used to help select the most promising sensors for user authentication. FS is one of the most widely used supervised feature selection methods due to its excellent performance. The Fisher Score enables finding a subset of features, such that in the data space spanned by the selected features, the distances between data points in different classes are as large as possible, while the distances between data points in the same class are as small as possible.

Table V shows the FS for different sensors that are widely implemented in smartphones and smartwatches. In this embodiment, it is seen that the magnetometer, orientation sensor and light sensor have lower FS scores than the accelerometer and gyroscope because they are influenced by the environment. This can introduce various background noise unrelated to the user's behavioral characteristics, e.g., the magnetometer may be influenced by the magnets.

Smartphone sensor information that is not intrinsically privacy sensitive includes measurements from an accelerometer, magnetometer, gyroscope, orientation sensor, ambient light, proximity sensor, barometric pressure and temperature. Other more privacy sensitive inputs include a user's location as measured by his GPS location, WLAN, cell tower ID and Bluetooth connections. Also privacy sensitive are audio and video inputs like the microphone and camera. These privacy sensitive sensor inputs require user permissions, for example, permissions that must be explicitly given on some Android devices. The contacts, running apps, apps' network communication patterns, browsing history, screen on/off state, battery status and so on, can also help to characterize a user. In preferred embodiments, sensors are chosen that do not require explicit permissions to be given, for example the GPS sensor, a camera, or a microphone. In preferred embodiments, sensors are selected that are commonly available on smartphones.

Therefore, in one embodiment, two sensors were selected, the accelerometer and gyroscope, because they have higher FS scores and furthermore, are the most common sensors built into current smartphones and smartwatches. These two sensors also represent different information about the user's behavior: 1) the accelerometer records coarse-grained motion patterns of a user, such as how she walks; and 2) the gyroscope records fine-grained motions of a user such as how she holds a smartphone. Furthermore, these sensors do not need the user's permissions, making them useful for continuous background monitoring in implicit authentication scenarios, without requiring user interaction. In some embodiments, only a single sensor is used. In others, two or more are used.

TABLE V
(Fisher Scores).

| | Smartphone | Smartwatch |
|---|---|---|
| Acc(x) | 3.13 | 3.62 |
| Acc(y) | 0.8 | 0.59 |
| Acc(z) | 0.38 | 0.89 |
| Mag(x) | 0.005 | 0.003 |
| Mag(y) | 0.001 | 0.0049 |
| Mag(z) | 0.0025 | 0.0002 |
| Gyr(x) | 0.57 | 0.24 |
| Gyr(y) | 1.12 | 1.09 |
| Gyr(z) | 4.074 | 0.59 |
| Ori(x) | 0.0049 | 0.0027 |
| Ori(y) | 0.002 | 0.0043 |
| Ori(z) | 0.0033 | 0.0001 |
| Light | 0.0091 | 0.0428 |

Once the sensors and features to be used for context and/or authentication are determined, there are still two parameters that can be considered: the window size and the size of the dataset.

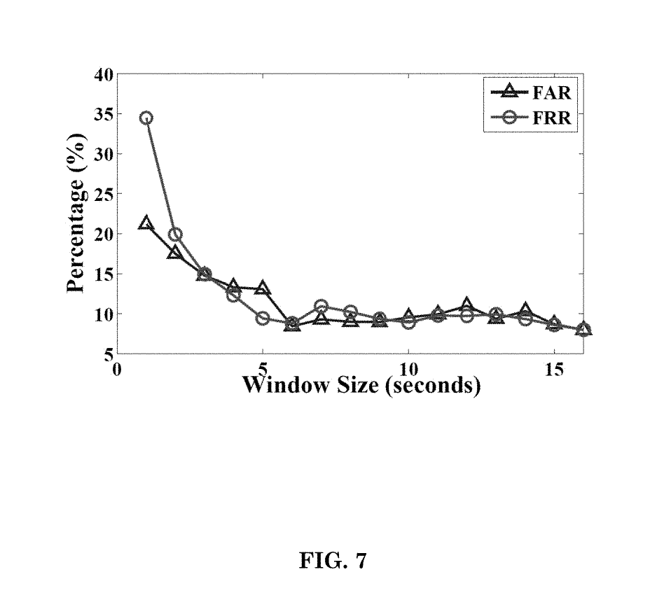

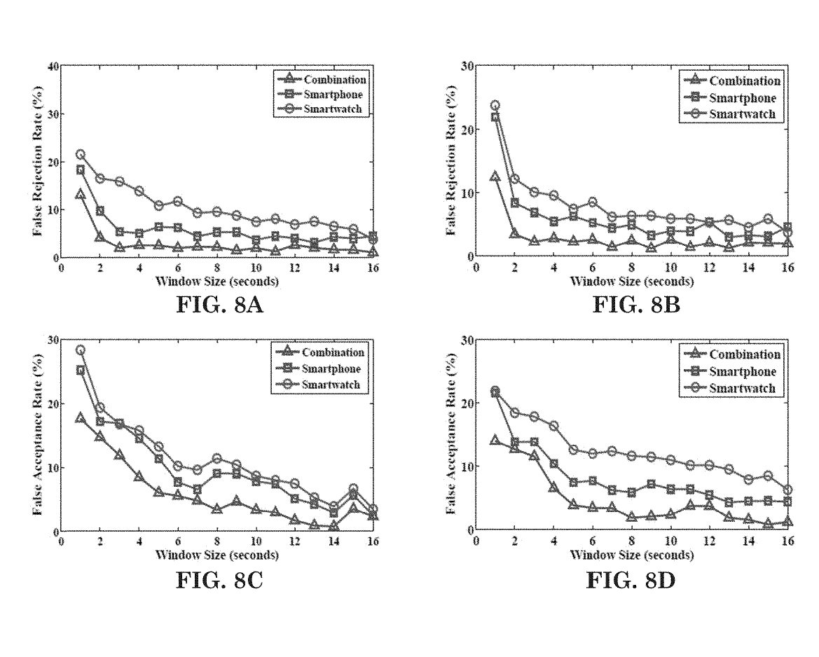

The window size is an important system parameter, which determines the time that the system needs to perform an authentication, i.e., window size directly determines the system's authentication frequency. The window size can be varied as desired. In one embodiment, the window size can be varied, for embodiment from 1 second to 16 seconds. Given a window size, for each target user, the system can utilize multi-fold (e.g., 10-fold, etc.) cross-validation for training and testing. In one embodiment, a 10-fold cross-validation was used, i.e., 9/10 data was used as the training data, and 1/10 used as the testing data. The false rejection rate (FRR) and false acceptance rate (FAR) are metrics for evaluating the authentication accuracy of a system. FAR is the fraction of other users' data that are misclassified as the legitimate user's data. FRR is the fraction of the legitimate user's data that are misclassified as other users' data. For security protection, a large FAR is more harmful than a large FRR. However, a large FRR will often degrade the usage convenience. FIG. 7 shows that, in one system configuration, the FAR and FRR become stable when the window size is greater than 6 seconds. FIGS. 8A-8D shows that the FRR and FAR for each context in another system configuration become stable when the window size is greater than 6 seconds. FIGS. 8A and 8B are the FRR under stationary and moving contexts, respectively. FIGS. 8C and 8D are the FAR under stationary and moving contexts, respectively. In FIGS. 8A-8D, the smartphone has better (lower) FRR and FAR than the smartwatch. The combination of the smartphone and smartwatch has the lowest FRR and FAR, and achieves the best authentication performance than using each alone.

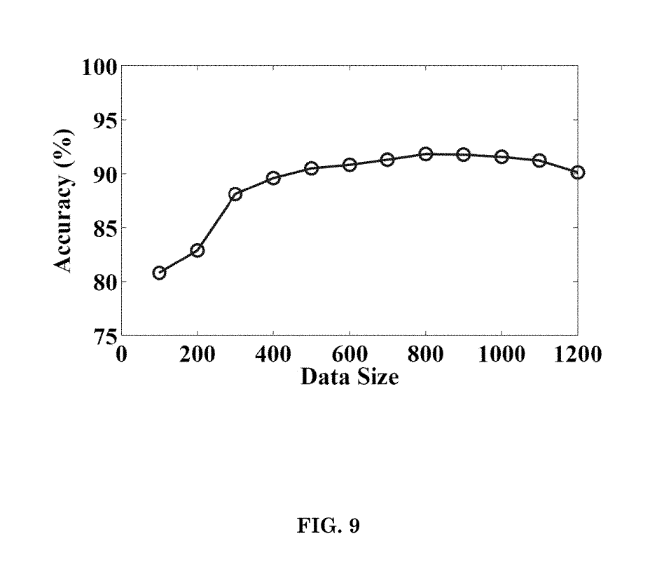

The size of the data set also affects the overall authentication accuracy because a larger training data set provides the system more information. As shown in FIG. 9, for one particular system configuration, training data set sizes from 100 to 1200 produced accuracies above 80%, although the maximum accuracy was seen at 800 in this configuration. The accuracy decreases after the training set size is larger than 800 because a large training data set is likely to cause over-fitting in the machine learning algorithms so that the constructed training model would introduce more errors than expected.

In cases where the sensor measurements originally obtained are too large to process directly, a re-sampling process can be utilized. This can done for several reasons, including to reduce the computational complexity, or to reduce the effect of noise by averaging the data points. For example, to reduce the data set by 5 times, 5 contiguous data points can be averaged into one data point.

Ideally, once the user has gotten used to the device and the device-specific ‘sensor behavior’ no longer changes, and the system has observed sufficient information to have a stable estimate of the true underlying behavioral pattern of that user, the system can now train the authentication classifier, optionally under various contexts. The system and method can automatically detect a context in a user-agnostic manner and can authenticate a user based on various authentication models. That is, the system can authenticate the users without requiring any specific usage context, making it more applicable in real world scenarios.

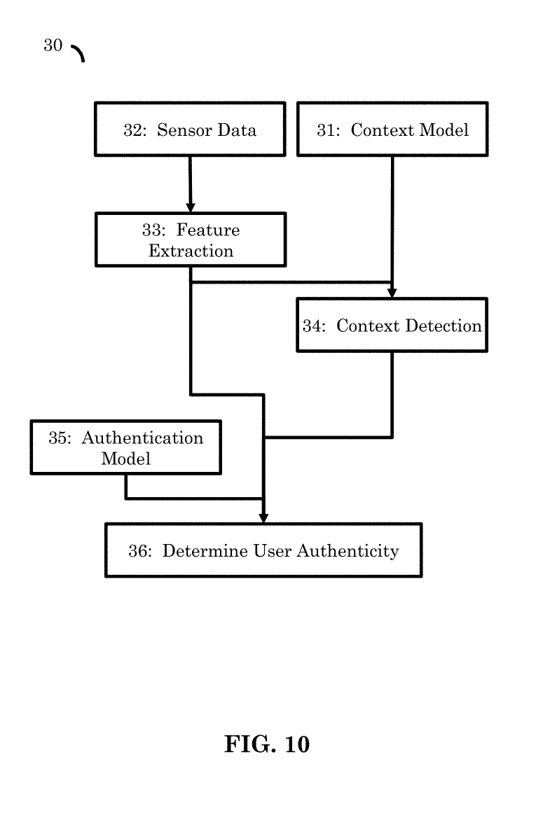

In real world situations, systems will generally not spend significant time in enrollment (20), but rather in the test phase (30). Referring to FIG. 10, sensor data (32) from at least one sensor is received, and features are extracted (33). Some or all of those features may be sent, along with the context model (31), for context detection (34). The features are also sent, along with an authentication model (35) to determine if the user is authentic (36). If context detection is utilized, the appropriate model for the given context is utilized. The output of the test phase is the positive or negative authentication result.

Referring back to FIG. 1, systems can also optionally utilize a retraining phase (40). There are many ways or reasons for retraining, but this may be done periodically, on demand, or when calculations related to authentication meet certain requirements.

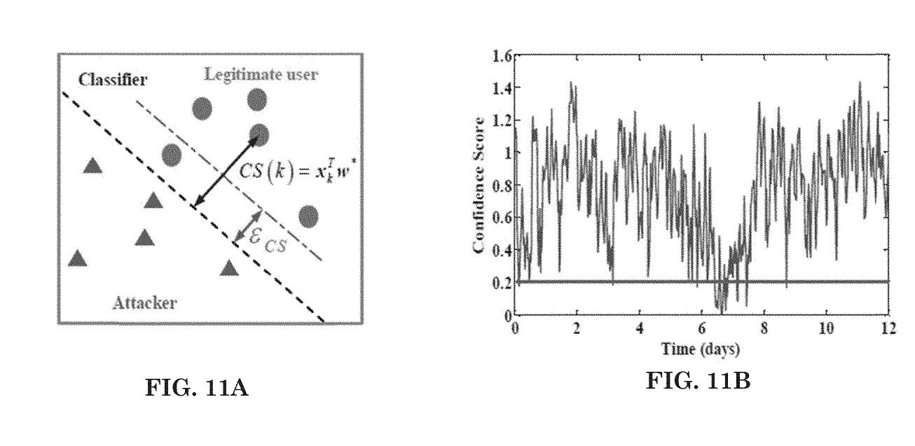

FIG. 11A illustrates the concept of behavioral drift. The behavioral drift of the legitimate user can be considered in embodied systems and methods. The user may change his or her behavioral pattern over weeks or months, which may cause more false alarms in implicit authentication. The authentication models can therefore be automatically updated based on triggers such as a confidence score for the authentication accuracy.

A confidence score (CS) for the k-th authentication feature vector xₖ^{T} can be defined in a variety of ways. One method is to define CS as the distance between xₖ^{T} and the corresponding authentication classifier w*.

CS(k)=xₖ^{T}w* (Eq. 11)

As the authentication classifier w* represents the classification boundary to distinguish the legitimate user and the adversaries, a lower confidence score (smaller distance between xₖ^{T} and w*) represents a less confident authentication result and suggests a change of user's behavioral pattern where retraining should be taken. For an authenticated user, one preferred embodiment involves determining if the confidence score is lower than a certain threshold ε_{CS} for a period of time T, then the system automatically retrains the authentication models.

FIG. 11B shows the confidence score of the time-series authentication feature vectors for a user. It can be seen that the confidence score decreases slowly in the first week. At the end of the first week, the confidence score experiences a period of low values (lower than a threshold ε_{CS}=0.2 for a period), indicating that the user's behavior changes to some extent during this week. In this situation, it would be helpful if the system automatically retrained the authentication models. Note that there are some earlier points lower than the threshold (0.2) but in this embodiment, they did not occur for a long enough period to trigger the retraining.

A system that recognizes a user's behavior drift by checking the confidence score could then go back to the training module again, and upload the legitimate user's authentication feature vectors to the training module until the new behavior (authentication model) is learned. Advanced approaches in machine unlearning can be utilized to update the authentication models faster than retraining from scratch. After retraining the user's authentication models, it can be seen that the confidence score increases to normal values from Day 8 in FIG. 11B.

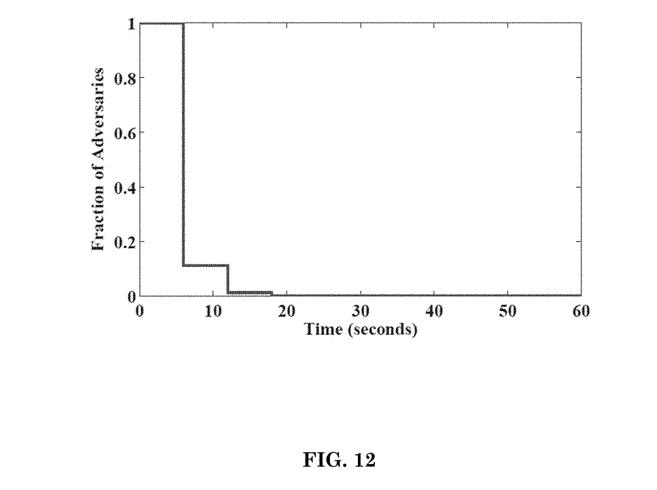

An attacker who has taken over a legitimate user's smartphone must not be allowed to retrain the authentication model. Fortunately, the attacker cannot trigger the retraining since, in order to trigger retraining, the confidence score should be positive and last for a period of time. However, the attacker is likely to have negative confidence scores, which cannot last for sufficient time to trigger retraining, since he can be detected rapidly. FIG. 12 depicts an attacker being detected in less than 18 seconds.

Recall that the goal of an attacker is to get access to the sensitive information stored in the cloud through the smartphone, or in the smartphone. This system and method achieves very low FARs when attackers attempt to use the smartphone with their own behavioral patterns.

This system and method are secure even against the masquerading attacks where an adversary tries to mimic the user's behavior. Here, ‘secure’ means that the attacker cannot cheat the system via performing these spoofing attacks and the system should detect these attacks in a short time. To evaluate this, an experiment was conducted to utilize a masquerading attack where the adversary not only knows the password but also observes and mimics the user's behavioral patterns. If the adversary succeeds in mimicking the user's behavioral pattern, then the system or method will misidentify the adversary as the legitimate user and he can thus use the smartphone normally.

In this experiment, subjects were asked to be a malicious adversary whose goal was to mimic the victim user's behavior to the best of his ability. One user's data was recorded and his/her model was built as the legitimate user. The other users tried to mimic the legitimate user and cheat the system to login. The victim user was recorded utilizing a test smartphone with a VCR. Subjects were asked to watch the video and mimic the behavior. Both the adversary and the legitimate user performed the same tasks, and the user's behavior is clearly visible to the adversary. Such an attack was repeated 20 times for each legitimate user and her corresponding ‘adversaries’. In order to show the ability of the test system in defending against these mimicry attacks, the percentage of people (attackers) who were still using the smartphone without being de-authenticated by the system were counted. FIG. 12 shows the fraction of adversaries that are recognized as legitimate users by the test system at time t, from which it can be seen how quickly the test system can recognize an adversary and terminate his access to the smartphone. At t=0, all the adversaries have access to the smartphone, but within 6 s, only 10% of adversaries have access. That is to say, the test system identified on average 90% of adversaries as unauthorized users within 6 s. By t=18 s, the test system identified all the adversaries. Therefore, the test system performed well in recognizing the adversary who is launching the masquerading attack.

Such experimental results also match with an analysis from a theoretical point of view. Assuming the probability to detect the attacker at each time window as p, then the chance that the attacker can escape from detection would be (1−p)ⁿ where n is the number of windows. Based on experimental results, a test system can achieve accuracy higher than 90%. Thus, within only three windows, the probability for the attacker to escape from detection is (1−0.9)³=0.1%.

Note that the window size for this experiment is 6 s and the actual authentication time for each window sample is 22.5 ms. Both the experimental and theoretical analysis show that the probability for the adversary to be misidentified as a legitimate user decreases very quickly with time. Therefore, embodiments of the claimed system and method can show excellent performance in defending against masquerading attacks.

Experiments utilizing various embodiments of the system and method have been conducted. In one experiment, users could use their smartphones and smartwatches as they normally do in their daily lives, without any constraints on the contexts under which they used their devices. Users were invited to take the smartphone and smartwatch for one to two weeks, and use them under free-form, real-use conditions. The accuracy of user authentication was evaluated when only the smartphone's sensor features from the accelerometer and gyroscope were used, and when both the smartphone and smartwatch's sensor features were used. The former had feature vectors with 7×2=14 elements, while the latter had feature vectors with 7×2×2=28 elements.

In another experiment, different machine learning algorithms were tested utilizing the same set of data. Some potential machine learning techniques include, but are not limited to decision trees, kernel ridge regression (KRR), support vector machine (SVM) algorithms, random forest, naïve Bayesian, k-nearest neighbors (K-NN), and least absolute shrinkage and selection operator (LASSO). It is envisioned that supervised, unsupervised and semi-supervised machine learning techniques, and deep learning techniques, can be applied. However, only certain supervised machine learning techniques are discussed in some detail herein.

Table VI shows user authentication results for a sample of machine learning techniques: Kernel ridge regressions (KRR), Support Vector Machines (SVM), linear regression, and naïve Bayes.

TABLE VI

| Method | FRR | FAR | Accuracy |
|---|---|---|---|
| KRR | 0.9% | 2.8% | 98.1% |
| SVM | 2.7% | 2.5% | 97.4% |
| Linear Regression | 12.7% | 14.6% | 86.3% |
| Naïve Bayes | 10.8% | 13.9% | 87.6% |

For the experiment disclosed above, KRR achieved the best accuracy. SVM also achieves high accuracy but the computational complexity was much higher than KRR. Linear regression and naïve Bayes have significantly lower accuracy compared to KRR and SVM, in this embodiment.

Kernel ridge regressions (KRR) have been widely used for classification analysis. The advantage of KRR is that the computational complexity is much less than other machine learning methods, e.g., SVM. The goal of KRR is to learn a model that assigns the correct label to an unseen testing sample. This can be thought of as learning a function which maps each data x to a label y. The optimal classifier can be obtained analytically according to

w*= [symbol] dρ∥w∥²+Σₖ₌₁^{N}(w^{T}xₖ−yₖ)² (Eq. 6)

where N is the data size and xₖ^{M×1} represents the transpose of Authenticate(k), the authentication feature vector, and M is the dimension of the authentication feature vector. Let X denote a M×N training data matrix X=[x₁, x₂, . . . x_{N}]. Let y=[y₁, y₂, . . . y_{N}]. \vec{φ}(xᵢ) denotes the kernel function, which maps the original data xᵢ into a higher-dimensional (J) space. In addition, Φ=[\vec{φ}(x₁), \vec{φ}(x₂), . . . \vec{φ}(x_{N})] and K=Φ^{T}Φ. This objective function in Eq. 6 has an analytic optimal solution where

w*=Φ[K+ρI_{N}]⁻¹y (Eq. 7)

By utilizing certain matrix transformation properties, the computational complexity for computing the optimal in Eq. 7 can be largely reduced from O(N^{2.373}) to O(M^{2.373}). This is a huge reduction in these embodiments, since N=800 data points, and M=28 features in the authentication feature vector.

The computational complexity of KRR is directly related to the data size according to Eq. 7. The computational complexity can be largely reduced to be directly related to the feature size. According to Eq. 7, the optimal classifier is

w*=Φ[K+ρI_{N}]⁻¹y

Define S=ΦΦ^{T}, where Φ=[\vec{φ}(x₁),\vec{φ}(x₂), . . . \vec{φ}(x_{N})]. By utilizing a matrix transformation method, the optimal solution in Eq. 6 is equivalent to

w*=[S+ρI_{J}]⁻¹Φy (Eq. 8)

The dominant computational complexity for Eq. 7 and Eq. 8 comes from taking the inversion of a matrix. Therefore, based on Eq. 7 and Eq. 8, the computational complexity is approximately min(O(N^{2.373}), O(J^{2.373})). If the identity kernel is utilized, the computational complexity can be reduced from O(N^{2.373}) to O(M^{2.373}) and is independent of the data size. Specifically, it is possible to construct 28-dimensional feature vectors (e.g., 4 time-domain features and 3 frequency-domain features for each of two sensors, for each device). Thus, the time complexity in the embodiment where 9/10 of the data was used for training, this reduced from O((800×9/10)^{2.373})=O(720^{2.373}) to only O(28^{2.373}). In this embodiment, the average training time is 0.065 seconds and the average testing time is 18 milliseconds, indicating the effectiveness of the system.

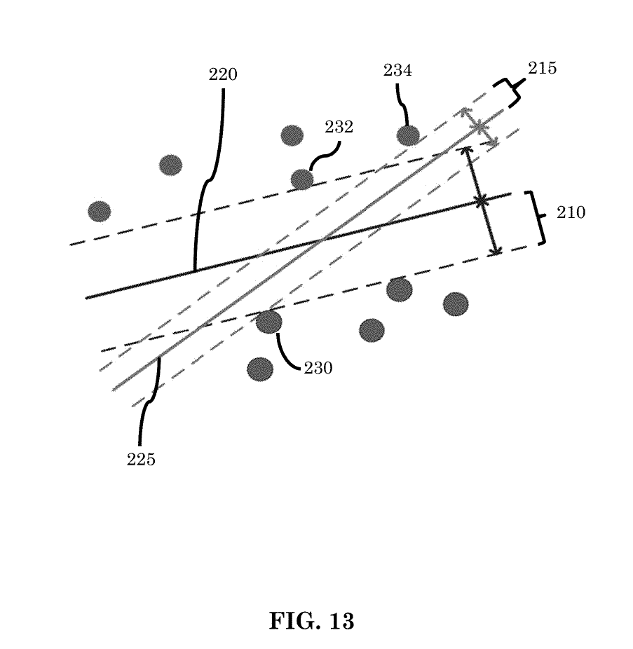

In other embodiments, Support Vector Machines (SVMs) is a preferred method. SVMs are state-of-the-art large margin classifiers, which represent a class of supervised machine learning algorithms. After obtaining the features from sensors, SVM can be used as the classification algorithm in the system. The training data is represented as [symbol] ={(xᵢ, y₁)εX×y:i=1, 2, . . . , n} for n data-label pairs. For binary classification, the data space is X= [symbol] ^{d} and the label set is y={−1, +1}. The predictor is w=x→y. The objective function is J(w, [symbol] ). The SVM finds a hyperplane in the training inputs to separate two different data sets such that the margin is maximized. FIG. 13 illustrates the concept of SVM classification. A margin (210, 215) is the distance from the hyperplane (220, 225) to a boundary data point (230, 232, 234). The boundary point is called a support vector and many support vectors may exist. The most popular method of training such a linear classifier is by solving a regularized convex optimization problem:

w*= [symbol] dλ∥wλ²+Σᵢ₌₁ⁿl(w,xᵢ,yᵢ) (Eq. 9)

where

l(w,xᵢ,yᵢ)=max(1−yw^{T}x,0) (Eq. 10)

The margin is in SVM. So, Eq. 9 minimizes the reciprocal of the margin (first part) and the misclassification loss (second part). The loss function in SVM is the Hinge loss (Eq. 10).

Sometimes, the original data points need to be mapped to a higher dimensional space by using a kernel function so as to make training inputs easier to separate. In one embodiment of the classification, the smartphone owner's data is labeled as positive and all the other users' data as negative. Then, such a model is exploited to do authentication. Ideally, only the user who is the owner of the smartphone is authenticated, and any other user is not authenticated. In one embodiment, LIBSVM was selected to implement the SVM. The input of the embodiment was n positive points from the legitimate user and n negative data points from randomly selected n other users, although other embodiments utilize other configurations, including but not limited to using n positive points from the legitimate user and m negative data points from z other users. The n positive points could be gathered in a variety of ways, such as gathering sensor data within a period of time before, during, and after when the legitimate user is using an explicit form of authentication (such as signing in with a password, pin, or using some biometric sensor). The output is the user's profile for the legitimate user.

In one embodiment, the testing module of the authentication app in a smartphone runs as threads inside the smartphone system process. An application was developed to monitor the average CPU and memory utilization of the smartphone and smartwatch while running the authentication app which continuously requested sensor data at a rate of 50 Hz on a Nexus 5 smartphone and a Moto 360 smartwatch. The CPU utilization for this embodiment was 5% on average and never exceeded 6%. The CPU utilization (and hence energy consumption) would scale with the sampling rate. The memory utilization in this embodiment was 3 MB on average. This is small enough to have negligible effect on overall smartphone performance.

To measure the battery consumption of the authentication app, the following four testing scenarios were considered: (1) Phone is locked (i.e., not being used) and app is off; (2) Phone is locked and the app is running; (3) Phone is under use and the app is off; and (4) Phone is under use and the app is running. For scenarios (1) and (2), the test time was 12 hours each. The smartphone battery was charged to 100% and the battery level was checked after 12 hours. The average difference of the battery charged level from 100% was reported. For scenarios (3) and (4), the phone under use means that the user keeps using the phone periodically. During the using time, the user keeps typing notes. The period of using and non-using is five minutes each, and the test time in total is 60 minutes. Again, the battery charge at the end is reported. For scenario 1, 2.8% battery usage; for scenario 2, 4.9% battery usage; for scenario 3, 5.2% battery usage, and for scenario 4, 7.6% battery usage. Thus, for this embodiment, the app consumed 2.1% more battery power when the app was on for scenarios 1 and 2, and 2.4% more battery power when the app was on for scenarios 3 and 4 where the phone is under use, which is an acceptable cost for daily usage.

The overall authentication performance of one embodiment is seen in Table VII, when the system had a window size of 6 seconds and the data size of 800. As seen in Table VII, the authentication methodology works well with just the smartphone, even without contexts; by using only the smartphone without considering any context, the system was shown to achieve authentication accuracy up to 83.6%. Further, auxiliary devices are helpful: by combining sensor data from the smartwatch with the smartphone sensor data, the authentication performance increases significantly over that of the smartphone alone, reaching 91.7% accuracy, with better FRR and FAR. Additionally, context detection is beneficial for authentication: the authentication accuracy is further improved, when the finer-grained context differences are taken into consideration, reaching 93.3% accuracy with the smartphone alone, and 98.1% accuracy with the combination of smartphone and smartwatch data. Lastly, the overall time for implementing context detection followed by user authentication is less than 21 milliseconds. This is a fast user authentication testing time, with excellent authentication accuracy of 98%, making this method and system efficient and applicable in real world scenarios.

TABLE VII

| Context | Device | FRR | FAR | Accuracy |
|---|---|---|---|---|
| w/o | Smartphone | 15.4% | 17.4% | 83.6% |
| context | Combination | 7.3% | 9.3% | 91.7% |
| w/ context | Smartphone | 5.1% | 8.3% | 93.3% |
| | Combination | 0.9% | 2.8% | 98.1% |

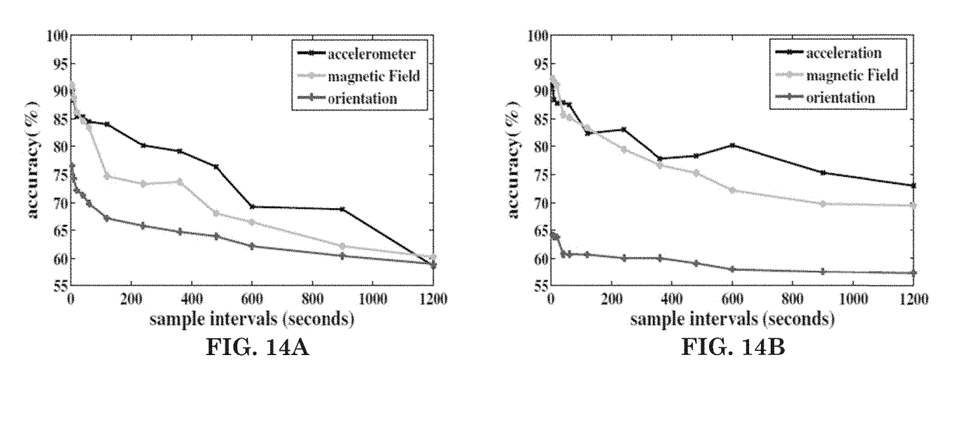

Simpler embodiments which do not use contexts, auxiliary devices (like a smartwatch) or frequency domain features are also used. In these simpler embodiments, using more than one sensor can still improve authentication accuracy. FIGS. 14A and 14B indicate accuracy data from single-sensor-based systems using two different data sets. FIG. 14A uses a first data set collected from a first group of individuals based on the smartphone, Google Nexus 5 with Android 4.4. It contains sensor data from the accelerometer, orientation sensor and magnetometer with a sampling rate of 5 Hz. The duration of the data collected is approximately 5 days for each user.

The pseudo code for implicit data collection in Android smartphones is given in Listing 1. The application contains two parts. The first part is an Activity, which is a user interface on the screen. The second part is a Service, which is running in the background to collect data. Each sensor measurement consists of three values, so a vector is constructed from these nine values from three sensors.

Different sampling rates were considered in the experiment, to construct data points. FIG. 14B uses a second data set that was collected from a second group of individuals. The data was collected from Android devices and contains sensor data from Wi-Fi networks, cell towers, application use, light and sound levels, acceleration, rotation, magnetic field and device system statistics. The duration of the data collected is approximately 3 weeks. For better comparison with the first data set, only the data collected from the accelerometer, orientation sensor and magnetometer is considered.

Listing 1. Pseudo code for PU dataset collection using Android smartphones.

```
1  In Activity.java
2  protected onCreate (Bundle Instance) {
3  register a BroadcastReceiver ;
4  set ContentViews and Buttons on the screen ;
5  }
6  private start_button = new Button.OnClickListener( ) {
7  start Service.java to collect and record data;
8  }
9  private stop_button = new Button.OnClickListener( ) {
10  stop Service.java;
11 }
12 In Service.java
13 private onStart(Intent intent, int startId) {
14  get Sensor Service ss;
15 for (Sensor s : sensors) {
16  ss register a sensorEventListener s ;
17 }
18 private sensorEventListener = new SensorEventListener( ) {
19  public onSensorChanged (SensorEvent event) {
20  case Sensor.TYPE_ACCELEROMETER: {
21  record data with time stamp in memory.
22  send data to Activity.java and show on the
                    screen.
23  }
24  case Sensor.TYPE_ORIENTATION: {
25  record data with time stamp in memory.
26  send data to Activity.java and show on the
                    screen.
27  }
28  case Sensor.TYPE_MAGNETIC_FIELD: {
29  record data with time stamp in memory.
30  send data to Activity.java and show on the
                    screen.
31  }
32  }
33 }
```

First, as seen in FIGS. 14A, 14B, accuracy increases with faster sampling rate because more detailed information is used from each sensor. Second, the accelerometer and the magnetometer have much better accuracy performance than the orientation sensor, especially for the second data set. This is likely because they both represent a user's longer-term patterns of movement (as measured by the accelerometer) and his general environment (as measured by the magnetometer). The orientation sensor represents how the user holds a smartphone, which may be more variable. Therefore, in this example, the accelerometer and magnetometer have better authentication accuracy. The difference is more marked in the second data set, but the overall relative accuracy of the three sensors is the same in both data sets. For a single sensor approach, the accuracy is generally below 90% even for fast sampling rates like 10 seconds, which may be sufficiently accurate in some situations.

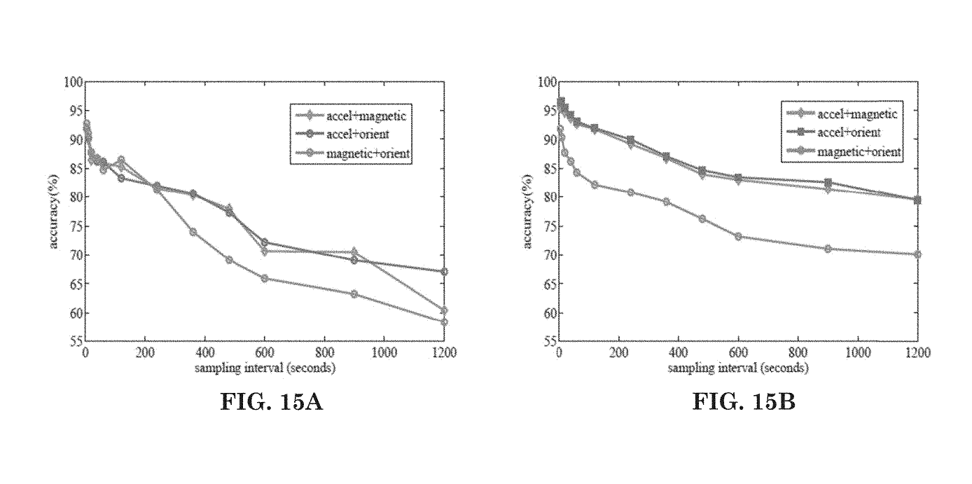

FIGS. 15A and 15B shows that for all pairwise combinations using the first (15A) and second (15B) data sets, accuracy increases with faster sampling rate. The combination of data from two sensors indeed gives better authentication accuracy than using a single sensor. As seen in Tables VIII and IX, the average improvement from one sensor to two sensors is approximately 7.4% in the first data set and 14.6% in the second data set when the sampling rate is 20 seconds. Also, using a combination of magnetometer and orientation sensors is worse than the other two pairs which include an accelerometer. In fact, in this experiment, the combination of magnetometer and orientation sensors is not necessarily better than using just the accelerometer. Therefore, choosing good sensors for a given application is very important. Also, using higher sampling rate gives better accuracy.

TABLE VIII
(First Data Set)

| | Sampling Rate(s) | | | | | | | | | | | |
|---|---|---|---|---|---|---|---|---|---|---|---|---|
| | 5 | 10 | 20 | 40 | 60 | 120 | 240 | 360 | 480 | 600 | 900 | 1200 |
| acc | 90.1 | 88.3 | 85.4 | 85.3 | 84.5 | 84.0 | 80.2 | 79.2 | 76.4 | 69.2 | 68.8 | 58.6 |
| mag | 91.0 | 88.9 | 86.2 | 84.6 | 83.4 | 74.7 | 73.3 | 73.7 | 68.0 | 66.4 | 62.2 | 60.2 |
| ori | 76.5 | 74.2 | 72.2 | 71.3 | 69.8 | 67.1 | 65.8 | 64.7 | 63.9 | 62.1 | 60.4 | 59.0 |
| acc + mag | 92.0 | 90.0 | 86.4 | 86.6 | 85.9 | 85.3 | 81.5 | 80.3 | 77.9 | 70.6 | 70.5 | 60.4 |
| acc + ori | 91.8 | 90.3 | 87.7 | 86.2 | 86.1 | 83.3 | 82.0 | 80.6 | 77.3 | 72.2 | 69.1 | 67.1 |
| mag + ori | 92.8 | 91.1 | 87.7 | 86.7 | 84.7 | 86.5 | 81.3 | 74.0 | 69.1 | 65.9 | 63.2 | 58.3 |
| all | 93.9 | 92.8 | 90.1 | 89.1 | 87.2 | 85.2 | 84.3 | 82.7 | 78.7 | 72.4 | 70.8 | 67.2 |

TABLE IX
(Second Data Set)

| | Sampling Rate(s) | | | | | | | | | | | |
|---|---|---|---|---|---|---|---|---|---|---|---|---|
| | 5 | 10 | 20 | 40 | 60 | 120 | 240 | 360 | 480 | 600 | 900 | 1200 |
| acc | 91.0 | 88.4 | 87.8 | 87.9 | 87.5 | 82.4 | 83.1 | 77.8 | 78.3 | 80.2 | 75.3 | 73.0 |
| mag | 92.3 | 91.2 | 91.0 | 85.7 | 85.2 | 83.4 | 79.5 | 76.7 | 75.3 | 72.2 | 69.8 | 69.5 |
| ori | 64.2 | 63.9 | 63.8 | 60.8 | 60.7 | 60.6 | 60.0 | 60.0 | 59.1 | 58.0 | 57.5 | 57.3 |
| acc + mag | 95.5 | 95.8 | 94.7 | 93.7 | 92.7 | 91.8 | 89.2 | 86.7 | 84.0 | 83.1 | 81.4 | 79.6 |
| acc + ori | 96.4 | 96.6 | 95.5 | 94.3 | 93.1 | 92.0 | 90.0 | 87.1 | 84.7 | 83.5 | 82.7 | 79.4 |
| mag + ori | 91.8 | 90.3 | 87.7 | 86.2 | 84.3 | 82.2 | 80.8 | 79.1 | 76.2 | 73.2 | 71.1 | 70.1 |
| all | 97.4 | 97.1 | 96.7 | 95.7 | 95.3 | 93.1 | 90.0 | 89.1 | 87.5 | 85.9 | 83.1 | 80.2 |

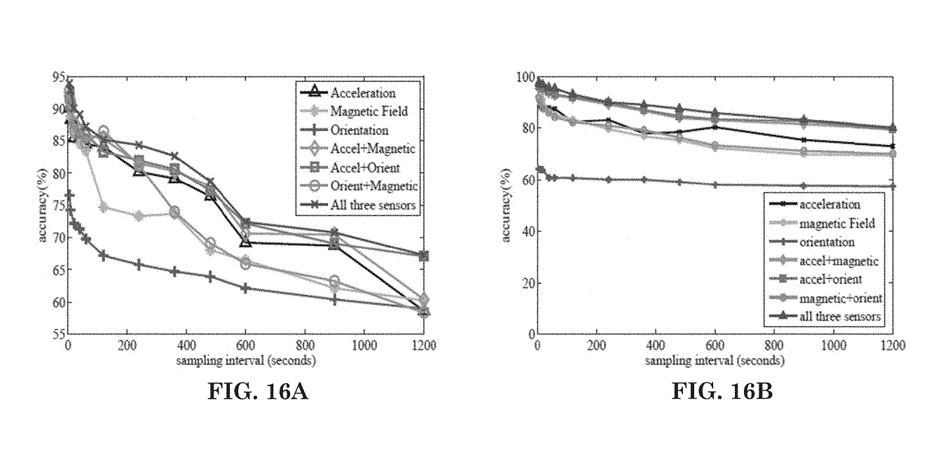

A three-sensor-based system was also compared with one and two sensor-based authentication experiments. From FIGS. 16A and 16B, and Tables VIII and IX, the three-sensor results are seen to give the best authentication accuracy, as represented by the top line with triangles in both data sets, seen more clearly as the highest value in each column in Tables VIII and IX (last row in each table labeled “all”). Again, the accuracy increases with faster sampling rates because more detailed information from each sensor is used. From FIGS. 16A and 16B, and Tables VIII and IX, when the sampling rate is higher than 4 minutes (samples every 240 seconds or less), the accuracy using 3 sensors in the first data set is better than 80%, while that in the second data set is better than 90%. The average improvement from two sensors to three sensors is 3.3% in the first data set and 4.4% in second data set when the sampling rate is 20 seconds. Furthermore, when the sampling rate is higher than 20 seconds, the accuracy in the first data set is better than 90%, while that in the second data set is better than 95%.

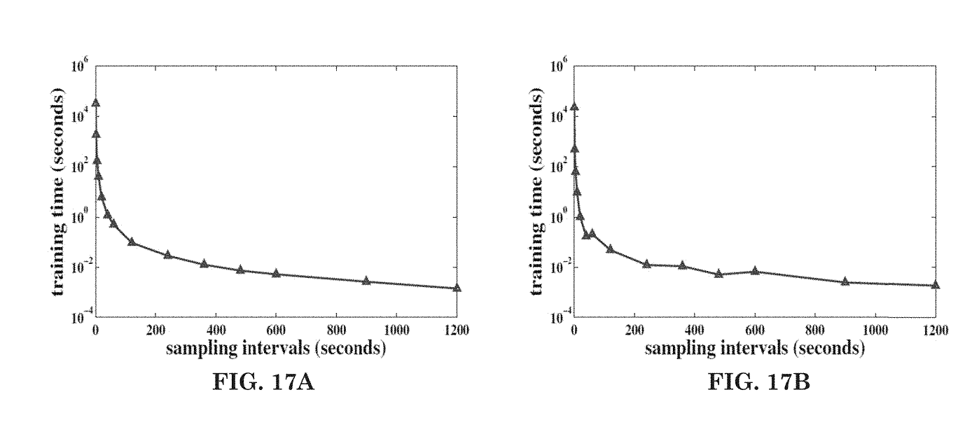

FIGS. 17A, 17B and Table X show that a higher sampling rate (smaller sampling interval) needs more time to train a user's profile using the SVM algorithm for three-sensor based systems. FIG. 17A represents the first data set, while FIG. 17B represents the second data set. The time exponentially increases with the increase of the sampling rate. It is a tradeoff between security and convenience. When the sampling interval is about 20 seconds, it only needs less than 10 seconds in the first data set (and roughly 1 second in the second data set) to train a user's profile (as seen in Table X), but the accuracy is higher than 90% in the first data set and 95% in the second data set (as seen in Table XIII and Table IX, respectively). This indicates that for some embodiments, a user only needs to spend less than 10 seconds to train a new model to do the implicit authentication for the whole day in the first data set and only 1 second for the second data set. A user or application could change the security level by changing the sampling rate of sensors.

TABLE X
(Training Times in seconds for two different data sets)

| | Sampling Interval (s) | | | | | | |
|---|---|---|---|---|---|---|---|
| | 1 | 2 | 5 | 10 | 20 | 40 | 60 |
| First Data Set | 33502 | 1855 | 170.72 | 39.85 | 6.07 | 1.19 | 0.51 |
| Second Data Set | 23101 | 485 | 62.41 | 9.43 | 1.02 | 0.21 | 0.17 |

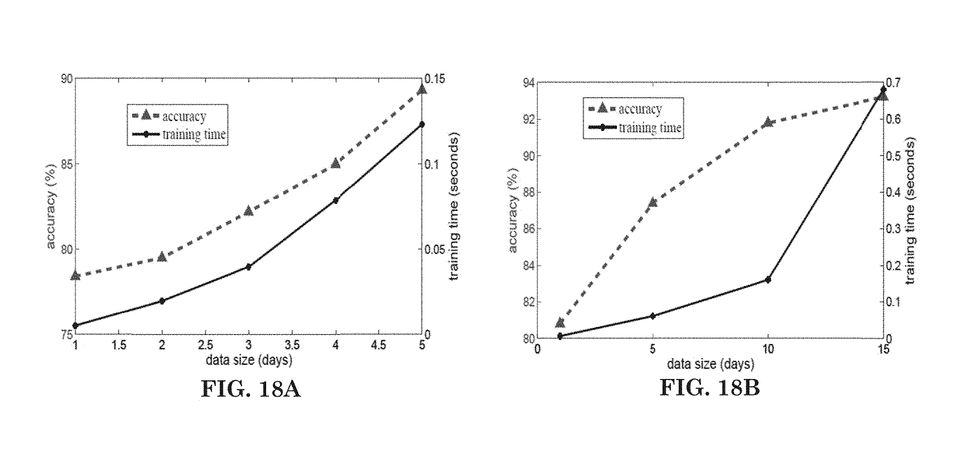

FIGS. 18A and 18B show another trade-off between security and convenience. With a sampling interval of 10 minutes and a training data size ranging from 1 day to 5 days in the first data set (FIG. 18A), and 1 day to 15 days in the second data set (FIG. 18B). The blue dashed line with triangles shows that the accuracy increases with the increase of training data size. The black solid line with circles shows that the training time increases with the increase of training data size.

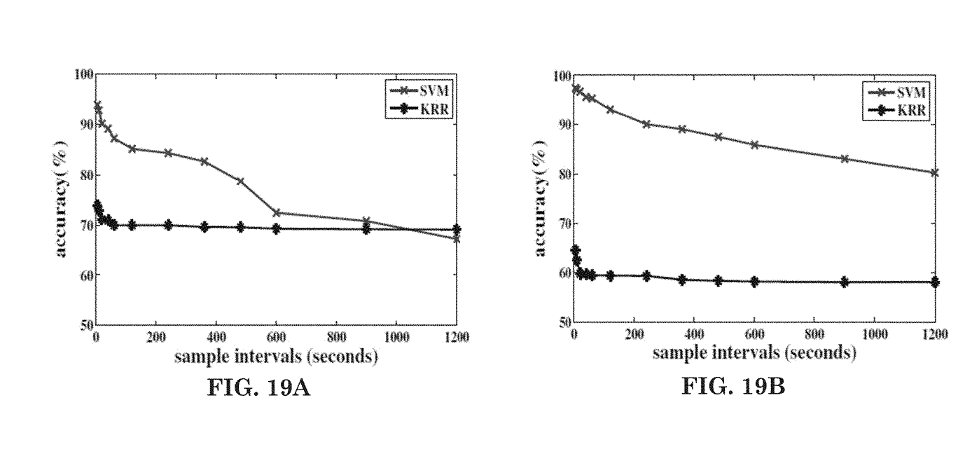

FIGS. 19A and 19B illustrate SVM performance versus another machine learning method, kernel ridge regression (KRR), for training the user's model for the first data set (FIG. 19A) and second data set (FIG. 19B). The performance is compared by using all three sensors. FIGS. 19A, 19B show that in this embodiment, using SVM gives much better authentication performance than using KRR.

In addition, this method can work in conjunction with other authentication methods. In some embodiments, both implicit authentication methods and explicit authentication methods, including biometrics such as fingerprint, or a signature or a graphical “password or pass-picture” entry, are used to authenticate a user. In one embodiment, the user is authenticated implicitly by the sensor data that is, in part, gathered while the user is explicitly authenticating, via a passcode, PIN, graphical password, signature or fingerprint. In other embodiments, the user is implicitly authenticated continuously, and an interface to allow explicit authentication is presented only if the user has already been implicitly authenticated. In a preferred embodiment, explicit authentication occurs first, and if that is successful then continuous implicit authentication is performed, with an interface presented for explicit authentication again only when implicit authentication fails.

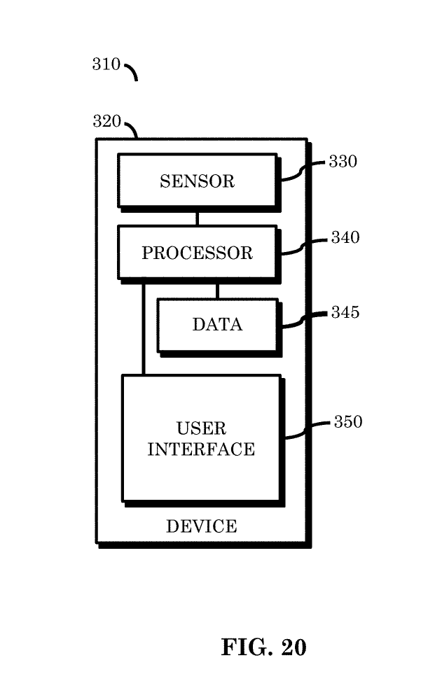

With reference to FIG. 20, one simplified embodiment of a system (310) practicing the present invention is disclosed. Device (320) comprises at least one sensor (330) that is in communication with a processor (340). Note that the term “processor” is used generally hereinafter, and could include hardwired logic, in addition to more traditional single or multi-core CPU processors. The processor (340) is configured to train an authentication model based on data from the sensor (330). Once the model is trained, the processor (340) authenticates a user based on the data from the sensor (330), and if authentication fails, the user can be prevented from accessing the device (320), or secret or sensitive information stored in the device (345). Optionally, a warning can be displayed on an optional user interface (350), an email message or other alert can be transmitted to a separate device or computer accessible by an authenticated user, or some other indication of a failed authentication can be generated.

In addition, the sensor data may also help to further authenticate an explicit authentication mechanism, including utilizing one or more fingerprints, or a signature or a graphical “password or pass-picture” entry. In some embodiments, the processor may be configured to store acquired sensor data while a user is explicitly authenticating themselves, such as via a passcode, PIN, signature or fingerprint. The features from the stored acquired sensor data can be used to add security to the explicit authentication, which could be a faked signature or stolen biometric or PIN. In other embodiments, the processor is configured to implicitly authenticate users continuously, and explicitly authenticate at certain times (such as when the user turns the phone on, or wakes the phone after a period of inactivity). In still other embodiments, the processor is configured to implicitly authenticate users continuously, and is further configured to display an interface to allow explicit authentication only if the user is currently implicitly authenticated. In a preferred embodiment, explicit authentication occurs first, and if that is successful then continuous implicit authentication is performed, with an interface presented for explicit authentication again only when implicit authentication fails.

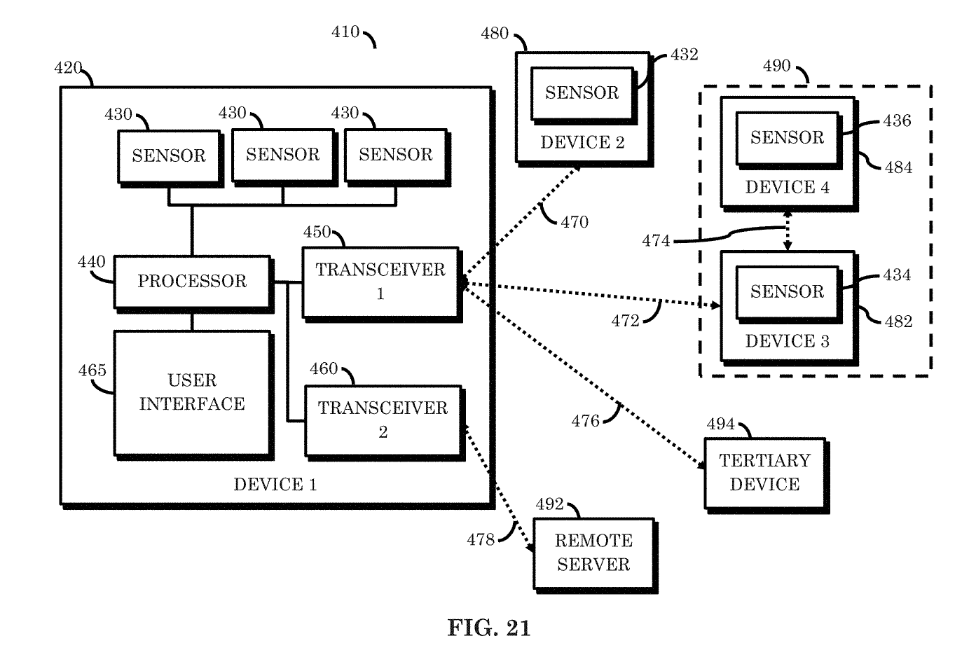

FIG. 21 depicts a more complex embodiment of a system (410). In this embodiment, a first device (420), which may be a smartphone, but is not limited to such, comprises at least one sensor (430), which include different types of sensors. For example, many smartphones incorporate at least one accelerometer, gyroscope, magnetometer, light sensor, proximity sensor, pressure sensor, orientation sensor, GPS, microphone, camera, and network sensors. Although only a single sensor is required, FIG. 21 illustrates several alternatives for how sensors can be utilized, including how sensors which can communicate information to device (420) could potentially be utilized. In FIG. 21, the system (410) is shown as having three sensors (430) that are internal to the device (420), one sensor (432) that is part of a second device (480), which may include but is not limited to wearable devices such as a smartwatch or smartglasses, and implantable devices, that can communicate through a wire or wireless communication link (470) with, for example, a transceiver (450) of the device (420). The system (410) also includes two sensors (434, 436) that are housed in components such as a third and fourth device (482, 484) of a second network (490), such as an Internet of Things (IoT) network. In the second network (490) shown in FIG. 21, a first component/device (482) could utilize a direct wired or wireless communication link (472) with the transceiver (450), although sensor data from a second component/device (484) that connects via a communication link (474) routing through at least one other device or component can be utilized as well. The protocols that are used to communicate sensor and authentication information are known, and it is envisioned that one skilled in the art would recognize which protocols would be effective for communicating among the various sensors. In some cases, all communications may utilize a single protocol. In others, the communication link (474) routing through at least one other device or component may utilize one existing protocol (e.g., Zigbee, etc.) while the direct communication link (472) may utilize a second existing protocol (e.g., bluetooth). In still other instances, some devices (480) may utilize one protocol to communicate with the device, while others (482, 484) may utilize one or more additional protocols.

The first device (420) may also have communication links (476) with tertiary devices without sensors (494) that communicate with the device (420). These tertiary devices (494) may interact with the device (420) in order to authenticate a user before allowing the user access to the tertiary device (494). For example, a thin client may utilize a connected smartphone's authentication process in order to provide access to the thin client.

In addition, a communication link can be created between the first device (420) and a remote server (492) through a transceiver. In FIG. 21, this is shown as being accomplished through a second transceiver (460), although any transceiver, including the first transceiver (450) could be utilized. The remote server could be cloud-based, or could simply be located elsewhere in a given home or facility. For example, a user could send sensor data to a server for training, but would otherwise accomplish the steps of the testing phase on the first device (420). Optionally or in addition, when a user first enrolls, a context model could be downloaded from a server.

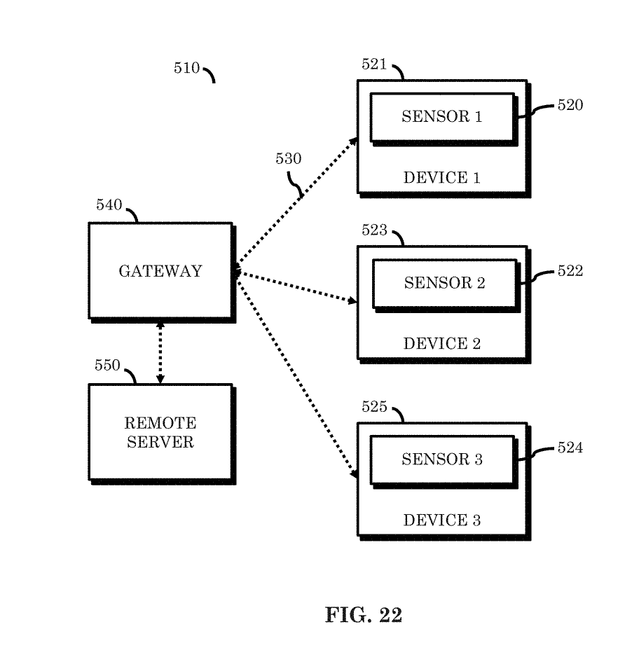

FIG. 22 illustrates a third embodiment, whereby sensors (520, 522, 524) in multiple devices (521, 523, 525) communicate with a remote server (550) via a gateway (540) through at least one communication link (530). In this particular embodiment, all authentications can be done remotely. Sensor data is sent through the gateway to the remote server, and very little, if any, user data would need to be stored locally on devices (521, 523, 525). For example, if a user wishes to access a file stored on a cloud server, a user's smartphone and smart glasses could collect sensor data, extract relevant feature vectors, and upload the feature vectors to the cloud server either continuously, or when access to a file is requested. The cloud server would have the authentication models for that user, and the server would try to authenticate the user, sending the file to the user's phone only if the user is successfully authenticated.

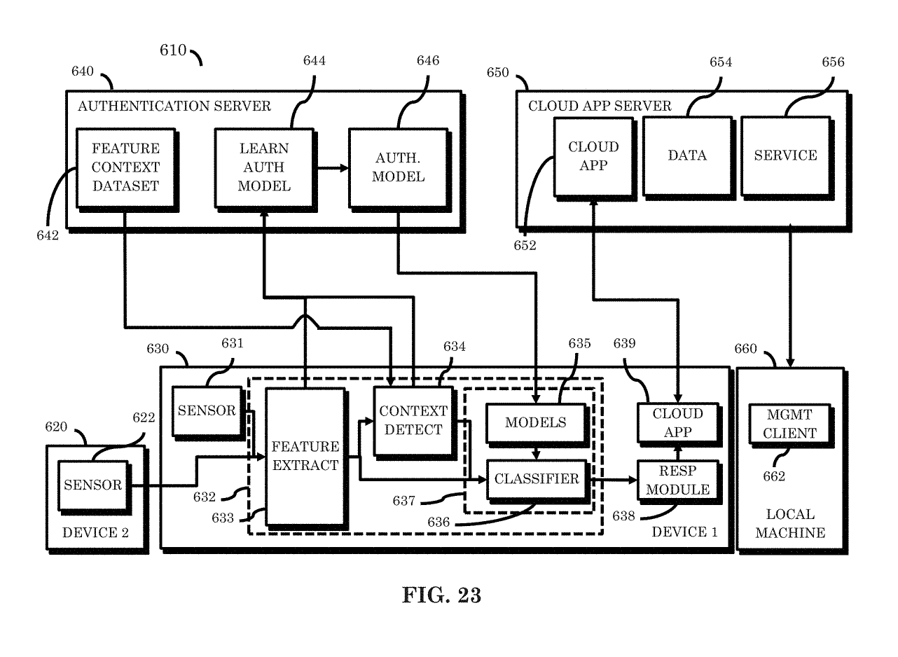

FIG. 23 illustrates another embodiment of a system (610). This system utilizes a two-device authentication configuration, which includes a mobile smartphone (630) and a user-owned wearable device (620). A smartwatch is used as an example, but other types of wearable devices, e.g., body sensors, can also be applied here. The authentication is designed for implicit authentication on the smartphone, where the smartwatch serves as important auxiliary information for improving authentication accuracy. The smartwatch keeps monitoring a user's raw sensors' (622) data and sends the information to the smartphone via, for example, Bluetooth. The smartphone also monitors the user's sensor (631) data as well.

The smartphone is in communication with an authentication server (640) and app server (650) in the cloud. In some embodiments, the app server can be in communication with a cloud customer or end user that is running cloud management client software (662) on a device capable of running the software, which may include the smartphone or other devices which may include, but are not limited to, a local machine (660). These communications will typically utilize secure communications via a known method, such as utilizing a secure sockets layer (SSL)/transport layer security (TLS) protocol.

The smartphone also runs the authentication testing module as a background service. Upon enrollment, in this embodiment, a context model/feature context dataset (642) is downloaded from the Authentication server (640) and provided to the testing module (632), for use with context detection (634). In the testing module, sensor data from the smartphone and smartwatch are sent to the feature extraction components (633) in both the time domain and the frequency domain, where fine-grained time-frequency features are extracted to form the authentication feature vector.

The extracted features are sent for context detection (634), both the features and the detected context are sent to the authentication server (640) to train (644) authentication models (646) based, for example, on different contexts. The authentication server provides efficient computation and enables the training data set to use sensor feature vectors of other enrolled smartphone users. When a legitimate user first enrolls in the system, the system keeps collecting the legitimate user's authentication feature vectors for training the authentication model. The system deploys a trusted Authentication cloud server to collect sensors' data from all the participating legitimate users. To protect a legitimate user's privacy, all users' data are anonymized. In this way, a user's training module can use other users' sensor data but has no way to know the other users' identities or behavioral characteristics. The training module uses the legitimate user's authentication feature vectors and other people's authentication feature vectors in the training algorithm to obtain the authentication model. After training, the authentication model is downloaded to the smartphone. The training module does not participate in the authentication testing process and is only needed for retraining when the device recognizes a user's behavioral drift, which is done online and automatically. Therefore, the system does not require continuous communication between the smartphone and the Authentication Server.

In some embodiments, behavioral drift can also be determined within the testing module (632) to update the authentication models (635) in the device (630) itself, without needing to go to the Authentication Server (640).

The authentication models (646) are then sent back to the testing module (632) on the smartphone (630), where they are stored locally (635) for use with the authentication module (637). To authenticate a user, the extracted features can be sent to a classifier (636) in the authentication module (637), where, in conjunction with locally-stored authentication models (635), a positive or negative authentication result is determined. This result is communicated to a response module (638). If the authentication results indicate the user is legitimate, then the Response Module will allow the user to use the cloud apps (639, 652) to access the data stored in the cloud (654) or cloud services (656) in the app server. Otherwise, the Response Module can take appropriate action, including but not limited to locking the smartphone, refusing access to the security-critical data, or performing further checking. If the legitimate user is misclassified, in order to unlock the smartphone, several possible responses can be implemented, depending on the situation and security requirements. For example, the legitimate user must explicitly re-authenticate by using a biometric that may have been required for initial log-in, e.g., a fingerprint. The legitimate user is motivated to unlock his device, whereas the attacker does not want to use his fingerprint because it will leave a trace to his identity. This architecture allows such explicit unlocking mechanisms, but is not restricted to one such mechanism.

Various modifications and variations of the invention in addition to those shown and described herein will be apparent to those skilled in the art without departing from the scope and spirit of the invention, and fall within the scope of the claims Although the invention has been described in connection with specific preferred embodiments, it should be understood that the invention as claimed should not be unduly limited to such specific embodiments.

What is claimed is:

1. A method for authenticating a user of a device, comprising the steps of:
training an authentication model utilizing at least one machine-learning technique; and
authenticating a user based on a plurality of measurements from at least one sensor and the authentication model.

2. The method according to claim 1, wherein the at least one sensor is a motion detection sensor.

3. The method according to claim 2 wherein the motion detection sensor is selected from the group consisting of accelerometer, gyroscope and orientation sensor.

4. The method according to claim 1, wherein the at least one sensor is an accelerometer and a gyroscope.

5. The method according to claim 1, wherein the at least one sensor is selected through the use of a Fisher Score.

6. The method according to claim 1, wherein the at least one sensor comprises at least a first sensor and a second sensor.

7. The method according to claim 6, wherein the second sensor is a sensor other than a motion detection sensor.

8. The method according to claim 7, wherein the second sensor is selected from the group consisting of heart rate monitor, pressure sensor, light sensor, proximity sensor or barometric sensor.

9. The method according to claim 6, wherein the first sensor is located in a first device, and the second sensor is located in a second device.

10. The method according to claim 9, wherein the first device is a smartphone.

11. The method according to claim 10, wherein the second device is a wearable device or implantable device.

12. The method according to claim 11, wherein the second device is a smartwatch.

13. The method according to claim 1, further comprising the step of:
continuously testing the user's behavior patterns and environment characteristics;
wherein the user is capable of being authenticated without interrupting user-device interactions.

14. The method according to claim 1, wherein the authentication model is adaptively updated to include temporal changes in the user's patterns.

15. The method according to claim 1, further comprising the step of determining the context of the plurality of measurements.

16. The method according to claim 15, wherein the context of the plurality of measurements is selected from the group consisting of moving and stationary contexts.

17. The method according to claim 1, wherein authentication requires testing of at least one feature selected from the group consisting of frequency domain features and time domain features.

18. The method according to claim 17, wherein authentication requires testing of at least one frequency domain feature and at least one time domain feature.

19. The method according to claim 17, wherein the at least one feature is chosen based on the results of:
at least one KS test, or
correlating pairs of features.

20. The method according to claim 1, wherein the at least one machine learning technique is selected from the group consisting of: decision trees, kernel ridge regression (KRR), support vector machine (SVM) algorithms, random forest, naïve Bayesian, k-nearest neighbors (K-NN), least absolute shrinkage and selection operator (LASSO), unsupervised learning and deep learning algorithms.

21. The method according to claim 1, wherein the at least one machine learning technique is configured such that the training time is dependent only on the number of features per feature vector.

22. The method according to claim 21 wherein the at least one machine learning technique is a Kernel Ridge Regression (KRR) algorithm that is manipulated to depend only on the number of features in a feature vector.

23. The method according to claim 1, wherein the authentication step is capable of preventing unauthorized users from gaining access to a device or a system accessible from the device without requiring explicit user-device interaction for authentication.

24. The method of claim 1, further comprising the step of retraining the authentication model.

25. The method according to claim 24, wherein the retraining step comprises at least one of:
adding at least one data point based on at least one measurement from the at least one sensor to at least some of the data used to train the authentication model, or
removing at least one data point from the data used to train the authentication model.

26. The method according to claim 24, wherein the retraining step automatically occurs in response to a determination that the confidence scores of a predetermined number of authentications is below a predetermined threshold.

27. The method according to claim 26, wherein the predetermined number of authentications is two, and the predetermined threshold is 0.2.

28. The method according to claim 1, further comprising enrolling in an authentication program, which comprises the steps of:
receiving a plurality of measurements from at least one sensor;
sending the plurality of measurements to a processor for training the user's profile; and
receiving an authentication model for performing implicit authentication.

29. The method according to claim 28, wherein the processor is located on a remote server.

30. The method according to claim 1, further comprising responding to an authentication failure by at least one of blocking further access to a device or to sensitive data or generating an alert.

31. The method according to claim 1, wherein a sampling rate of the at least one sensor is adjustable.

32. The method according to claim 1, wherein the method is performed at least in part on a remote server in communication with the device.

33. The method according to claim 1, wherein the at least one sensor does not require a user to give explicit permission for the plurality of measurements to be utilized for authentication.

34. The method according to claim 1, wherein the at least one sensor is not a GPS sensor, a sensor for a camera, or a microphone.

35. The method according to claim 1, wherein the training does not require a user to follow a script.

36. The method according to claim 1, wherein the training requires less than about 20 seconds of computation time.

37. A system for authenticating a user, comprising:
at least one sensor;
at least one processing element configured to:
receive a plurality of measurements based on data from at least one sensor; and
train a user authentication model based on the plurality of measurements from the at least one sensor using at least one machine learning technique.

38. The system of claim 37, wherein the at least one processing element is further configured to:
receive a second plurality of measurements from the at least one sensor; and
authenticate a user based on the second plurality of measurements and the user authentication model.

39. The system of claim 37, further comprising at least one additional processing element configured to:
receive the user authentication model from the at least one processing element;
receive a second plurality of measurements based on data from the at least one sensor; and
authenticate a user based on the second plurality of measurements and the user authentication model.

40. The system of claim 37, wherein the at least one processor is further configured to prevent an unauthorized user from gaining access to a device without requiring explicit user-device interaction.

41. The system of claim 37, wherein the at least one processor is further configured to prevent an unauthorized user from gaining access to a system controllable from a device without requiring explicit user-device interaction.

42. The system of claim 37, wherein the authentication is conducted via a smartphone application.

43. The system of claim 37, wherein authentication is conducted using computing resources of a device and a server.

44. The system of claim 37, wherein at least one of the at least one sensor is located in a first device remote from a second device housing the at least one processor.

45. The system of claim 44, further comprising a third device requesting authentication from the processor.

46. A method for authenticating a user of a device, comprising the steps of:
receiving a plurality of sensor measurements;
extracting at least one feature vector from the plurality of sensor measurements; and
determining whether a user is authentic based on the extracted feature vector and an authentication model trained utilizing at least one machine learning technique.

47. The method according to claim 46, wherein the plurality of sensor measurements are received from at least one motion detection sensor.

48. The method according to claim 46, wherein the plurality of sensor measurements are received from an accelerometer and a gyroscope.

49. The method according to claim 46, wherein the plurality of sensor measurements are received from at least one sensor selected through the use of a Fisher Score.

50. The method of claim 46, wherein the plurality of sensor measurements are received from a plurality of sensors.

51. The method of claim 50, wherein the plurality of sensors are located in a plurality of devices.

52. The method according to claim 51, wherein at least one of the plurality of devices is a wearable device or implantable device.

53. The method according to claim 52, wherein at least one of the plurality of devices is a smartphone.

54. The method according to claim 46, wherein the plurality of sensors comprises at least one motion detection sensor and at least one sensor other than a motion detection sensor.

55. The method according to claim 54, wherein the at least one sensor other than a motion detection sensor is selected from the group consisting of heart rate monitor, pressure sensor, light sensor, proximity sensor or barometric sensor.

56. The method according to claim 54 wherein the at least one motion detection sensor is selected from the group consisting of accelerometer, gyroscope and orientation sensor.

57. The method according to claim 46, further comprising the step of:
continuously testing the user's behavior patterns and environment characteristics;
wherein the user is capable of being authenticated without interrupting user-device interactions.

58. The method according to claim 46, wherein the authentication model is adaptively updated to include temporal changes in the user's patterns.

59. The method according to claim 46, further comprising the step of determining the context of the plurality of measurements.

60. The method according to claim 59, wherein the context of the plurality of measurements is selected from the group consisting of moving and stationary contexts.

61. The method according to claim 46, wherein authentication requires testing of at least one feature selected from the group consisting of a frequency domain feature and a time domain feature.

62. The method according to claim 61, wherein the at least one feature comprises at least one frequency domain feature and at least one time domain feature.

63. The method according to claim 62, wherein the at least one feature is chosen based on the results of:
at least one KS test, or
correlating pairs of features.

64. The method according to claim 46, wherein the at least one machine learning technique is configured such that the training time and authentication time are substantially dependent only on the number of features per feature vector.

65. The method according to claim 46, wherein the at least one machine learning technique is selected from the group consisting of: decision trees, kernel ridge regression (KRR), support vector machine (SVM) algorithms, random forest, naïve Bayesian, k-nearest neighbors (K-NN), least absolute shrinkage and selection operator (LASSO), unsupervised learning and deep learning algorithms.

66. The method according to claim 46, wherein the determination step is capable of preventing unauthorized users from gaining access to a device or a system accessible from the device without requiring explicit user-device interaction for authentication.

67. The method according to claim 46, wherein the authentication model is based on a plurality of measurements from the at least one sensor so as to allow authentication of the user implicitly.

68. The method of claim 46, further comprising the step of retraining the authentication model.

69. The method according to claim 68, wherein the retraining step comprises at least one of:
adding at least one data point based on at least one measurement from a sensor to at least some of the data used to train the authentication model, or removing at least one data point from the data used to train the authentication model.

70. The method according to claim 68, wherein the retraining step automatically occurs in response to a determination that the confidence scores of a predetermined number of authentications is below a predetermined threshold.

71. The method according to claim 70, wherein the predetermined number of authentications is two and the predetermined threshold is 0.2.

72. The method according to claim 46, further comprising enrolling in an authentication program, which comprises the steps of:
receiving a plurality of measurements from at least one sensor;
sending the plurality of measurements to a processor for training the user's profile; and
receiving an authentication model for performing implicit authentication.

73. The method according to claim 72, wherein the processor is located on a remote server.

74. The method according to claim 46, further comprising responding to an authentication failure by at least one of blocking further access to a device, blocking further access to sensitive data, or generating an alert.

75. The method according to claim 46, wherein a sampling rate of the at least one sensor is adjustable.

76. The method according to claim 46, wherein the method is performed at least in part on a remote server in communication with the device.

77. The method according to claim 46, wherein the plurality of sensor measurements are received from at least one sensor which does not require a user to give explicit permission for the plurality of measurements to be utilized for authentication.

78. The method according to claim 46, wherein the plurality of sensor measurements are not received from a GPS sensor, a sensor for a camera, or a microphone.

79. The method according to claim 46, wherein the training does not require a user to follow a script.

80. The method according to claim 46, wherein the training requires less than about 20 seconds of computation time.
